(19) United States
(12) Patent Application Publication
(10) Pub. No.: US 2010/0027510 A1
(43) Pub. Date: Feb. 4, 2010

(54) ENHANCED IDLE HANDOFF TO SUPPORT FEMTO CELLS

(75) Inventors: Srinivasan Balasubramanian, San Diego, CA (US); Manoj M. Deshpande, San Diego, CA (US); Mehmet Yavuz, San Diego, CA (US); Jen Mei Chen, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/511,901

(22) Filed: Jul. 29, 2009

Related U.S. Application Data
(60) Provisional application No. 61/086,113, filed on Aug. 4, 2008.

(51) Int. Cl. H04W 36/30

(52) U.S. Cl. 370/332

(57) ABSTRACT

Systems and methodologies are described that facilitate performing idle handoff in a wireless communication environment. Signal quality of a pilot received from a base station can be measured, and a type (e.g., femto, macro, . . . ) of the base station from which the pilot is received can be identified. According to an example, when the type of the base station is identified as being a femto cell base station, the base station can be recognized as being either preferred or non-preferred. Further, a linger timer can be initiated when the signal quality of the pilot exceeds an entry threshold and the base station is identified as a femto cell base station. Moreover, idle handoff to the base station can be performed upon expiration of the linger timer as a function of at least one subsequent measurement of signal quality of the pilot received from the base station.

### CLAIM OF PRIORITY UNDER 35 U.S.C. §119

The present Application for Patent claims priority to Provisional Application No. 61/086,113 entitled “SYSTEM AND METHOD FOR ENHANCED IDLE HANDOFF TO SUPPORT FEMTO CELLS” filed Aug. 4, 2008, and assigned to the assignee hereof and hereby expressly incorporated by reference herein.

### BACKGROUND

1. Field

The following description relates generally to wireless communications, and more particularly to leveraging a linger timer to enhance idle handoff effectuated by a mobile device in a wireless communication environment.

2. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Heterogeneous wireless communication systems commonly can include various types of base stations, each of which can be associated with differing cell sizes. For instance, macro cell base stations typically leverage antenna(s) installed on masts, rooftops, other existing structures, or the like. Further, macro cell base stations oftentimes have power outputs on the order of tens of watts, and can provide coverage for large areas. The femto cell base station is another class of base station that has recently emerged. Femto cell base stations are commonly designed for residential or small business environments, and can provide wireless coverage to mobile devices using a wireless technology (e.g., 3GPP Universal Mobile Telecommunications System (UMTS) or Long Term Evolution (LTE), 1x Evolution-Data Optimized (1xEV-DO), . . . ) to communicate with the mobile devices and an existing broadband Internet connection (e.g., digital subscriber line (DSL), cable, . . . ) for backhaul. A femto cell base station can also be referred to as a Home Node B (HNB), a femto cell, or the like. Examples of other types of base stations include pico cell base stations, micro cell base stations, and so forth.

In a wireless communication system that includes various types of base stations, a mobile device can repeatedly enter and exit coverage areas associated with femto cell base stations. Under drive-by or walk-by scenarios, the mobile device can frequently encounter femto cell base stations and can potentially switch between femto and macro networks. For example, the mobile device conventionally can register with a femto cell base station and quickly thereafter leave the femto cell base station (e.g. register with a nearby macro cell base station, . . . ). Thus, reselection and registration can unnecessarily be performed, which causes increased network traffic (e.g., loading associated with registrations, . . . ) corresponding to entering the femto cell base station (e.g., from a nearby macro cell base station, . . . ) and exiting the femto cell base station (e.g., to return to the nearby macro cell base station, . . . ). Further, unnecessary reselection and registration can detrimentally impact standby time (e.g., battery life, . . . ) of the mobile device.

Moreover, common metrics utilized to evaluate mobility of mobile devices can be unreliable. For instance, high mobility within a cell can count as low mobility, while a stationary mobile device can be declared as having high mobility due to radio frequency (RF) fluctuation. Hence, conventional techniques can be unable to adequately account for mobility of mobile devices. According to another example, if a mobile device ignores a femto cell base station (e.g., refrains from handing into the femto cell base station from a macro cell base station, . . . ), various problems can result such as dropped calls, missed pages, and so forth.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with performing idle handoff in a wireless communication environment. Signal quality of a pilot received from a base station can be measured, and a type (e.g., femto, macro, . . . ) of the base station from which the pilot is received can be identified. According to an example, when the type of the base station is identified as being a femto cell base station, the base station can be recognized as being either preferred or non-preferred. Further, a linger timer can be initiated when the signal quality of the pilot exceeds an entry threshold and the base station is identified as a femto cell base station. Moreover, idle handoff to the base station can be performed upon expiration of the linger timer as a function of at least one subsequent measurement of signal quality of the pilot received from the base station.

According to related aspects, a method is described herein. The method can include measuring a signal quality of a pilot received from a base station. Further, the method can include identifying whether the base station from which the pilot is received is a femto cell base station or a macro cell base station. Moreover, the method can comprise initiating a linger timer when the signal quality of the pilot exceeds an entry threshold and the base station is identified as a femto cell base station. The method can also include performing idle handoff to the base station upon expiration of the linger timer as a function of at least one subsequent measurement of signal quality of the pilot received from the base station.

Another aspect relates to a wireless communications apparatus. The wireless communications apparatus can include at least one processor. The at least one processor can be configured to monitor a signal quality of a pilot received from a base station. The at least one processor can also be configured to identifying a type of the base station from which the pilot is received. Moreover, the at least one processor can be configured to recognize whether the base station is preferred or non-preferred when the type of the base station is identified as a femto cell base station. Further, the at least one processor can be configured to start a linger timer when the signal quality of the pilot is above an entry threshold and the type of the base station is identified as a femto cell base station. The at least one processor can additionally be configured to effectuate idle handoff to the base station upon expiration of the linger timer as a function of at least one subsequent measurement of signal quality of the pilot received from the base station and whether the base station is recognized as preferred or non-preferred.

Yet another aspect relates to a wireless communications apparatus. The wireless communications apparatus can include means for measuring a signal quality of a pilot obtained from a base station. Further, the wireless communications apparatus can include means for recognizing a type of the base station from which the pilot is obtained. Moreover, the wireless communications apparatus can include means for starting a linger timer when the signal quality of the pilot is above an entry threshold and the base station is recognized as a femto cell base station. Also, the wireless communications apparatus can comprise means for effectuating idle handoff to the base station upon expiration of the linger timer based upon one or more subsequent measurements of signal quality of the pilot obtained from the base station.

Still another aspect relates to a computer program product that can comprise a computer-readable medium. The computer-readable medium can include code for causing at least one computer to measure a signal quality of a pilot received from a base station. The computer-readable medium can further comprise code for causing at least one computer to identify whether the base station from which the pilot is received is a femto cell base station or a macro cell base station. Moreover, the computer-readable medium can include code for causing at least one computer to initiate a linger timer when the signal quality of the pilot exceeds an entry threshold and the base station is identified as a femto cell base station. Further, the computer-readable medium can include code for causing at least one computer to perform idle handoff to the base station upon expiration of the linger timer as a function of at least one subsequent measurement of signal quality of the pilot received from the base station.

Yet another aspect relates to an apparatus that can include a pilot strength measurement component that evaluates signal quality of each pilot received from one or more base stations. Moreover, the apparatus can include a type identification component that detects whether each received pilot corresponds to a femto cell base station or a macro cell base station. The apparatus can also include a timer component that initiates a linger timer for a particular pilot recognized as corresponding to a femto cell base station with a signal quality detected by pilot strength measurement component above an entry threshold. Further, the apparatus can include a handover selection component that evaluates whether to perform an idle handover to the femto cell base station at a time of expiration of the linger timer.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example system that employs a linger timer in connection with idle handoff in a wireless communication environment.

FIG. 3 is an illustration of an example system that facilitates recognizing base station types in a wireless communication environment.

FIG. 4 is an illustration of an example system that enables a mobile device to handoff to a disparate base station from a source base station by leveraging a linger timer in a wireless communication environment.

FIG. 5 is an illustration of an example system that enables a mobile device to remain associated with a preferred femto cell base station in preference to disparate base stations (e.g., non-preferred femto cell base station, macro cell base station, . . . ) in a wireless communication environment.

FIG. 6 is an illustration of an example system that performs off frequency scans (OFSs) in connection with idle handoff procedures in a wireless communication environment.

FIG. 7 is an illustration of an example methodology that facilitates evaluating whether to effectuate an idle handoff in a wireless communication environment.

FIG. 8 is an illustration of an example methodology that facilitates maintaining an association with a preferred femto cell base station in a wireless communication environment.

FIG. 9 is an illustration of an example methodology that facilitates utilizing a first linger timer for a set of preferred femto cell base stations and a second linger timer for a set of non-preferred femto cell base stations in a wireless communication environment.

FIG. 10 is an illustration of an example mobile device that evaluates whether to perform an idle handoff in a wireless communication system.

FIG. 11 is an illustration of an example system that transmits pilots in a wireless communication environment.

FIG. 12 is an illustration of an example wireless communication system, configured to support a number of users, in which the teachings herein may be implemented.

FIG. 13 is an illustration of an example communication system where one or more femto nodes are deployed within a network environment.

FIG. 14 is an illustration of an example of a coverage map where several tracking areas (or routing areas or location areas) are defined, each of which includes several macro coverage areas.

FIG. 15 is an illustration of an example wireless network environment that can be employed in conjunction with the various systems and methods described herein.

FIG. 16 is an illustration of an example system that enables effectuating an idle handoff in a wireless communication environment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, a Node B, an Evolved Node B (eNode B, eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and Ultra Mobile Broadband (UMB) are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

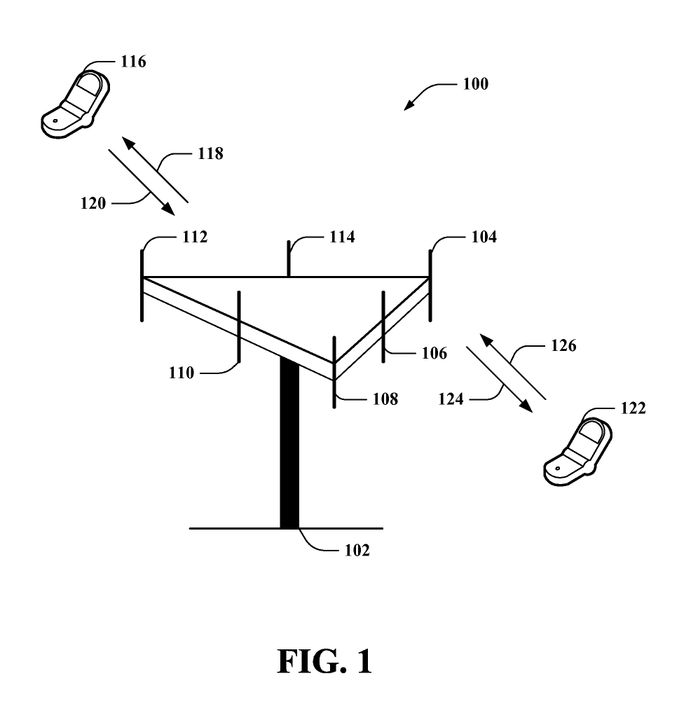

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices.

System 100 can support efficient performance of idle handoff procedures. For instance, base station 102 can be a macro cell base station, a femto cell base station, or the like. Moreover, neighbor base station(s) (not shown) can be located nearby base station 102, and these neighbor base station(s) can be macro cell base station(s), femto cell base station(s), etc. Mobile devices 116 and 122 can each obtain pilots respectively transmitted by base station 102 and neighbor base station(s). For example, the pilots can be received during idle mode searches performed by mobile devices 116 and 122. Moreover, mobile devices 116 and 122 can measure strengths, signal qualities, etc. of the obtained pilots.

Further, a mobile device (e.g., mobile device 116, mobile device 122, . . . ) can discern whether a received pilot originated from a macro cell base station or a femto cell base station (e.g. whether the received pilot is a macro pilot or a femto pilot, . . . ). Upon detecting a pilot sent from a femto cell base station with a strength, signal quality, etc. above an entry threshold, the mobile device can start a linger timer. When the linger timer expires, the mobile device can analyze whether to perform idle handoff to the femto cell base station based at least in part upon one or more subsequent measurements of strength, signal quality, etc. related to the pilot received from the femto cell base station.

Thus, when camped on a source base station (e.g., base station 102, neighbor base station, . . . ), the femto cell base station can be identified by the mobile device as a candidate for handoff at a point in time when a pilot corresponding to the femto cell base station is detected as being above an entry threshold, and the mobile device can initiate a linger timer at such point in time. For instance, the linger timer can be applied when the source base station is a macro cell base station (e.g., transitioning from a macro cell base station to the identified femto cell base station, . . . ) or a femto cell base station that belongs to a differing network (e.g., transitioning from a femto cell base station that belongs to a first network to the identified femto cell base station that belongs to a differing second network, . . . ). The mobile device can wait until expiration of a period of time associated with the linger timer to evaluate whether to handoff to the femto cell base station and/or effectuate such handoff to the femto cell base station. Hence, the mobile device can remain camped on the source base station during the period of time associated with the linger timer. By remaining camped on the source base station, a quick transition between handing off to a femto cell base station and back to the source base station, which oftentimes can be encountered when employing conventional techniques when the mobile device is operating under a mobility scenario, can be mitigated. The mobile device can see the femto cell base station for at least a minimum period of time set forth by the linger timer before effectuating reselection and/or registration. By leveraging the aforementioned linger timer, standby time of the mobile device can be significantly improved. Further, an amount of costly network traffic corresponding to unnecessary registrations with femto cell base stations can be reduced by utilizing the foregoing linger timer.

Moreover, a femto cell base station can be preferred or non-preferred for a mobile device (e.g., mobile device 116, mobile device 122, . . . ). The mobile device can thus distinguish a preferred femto cell base station from a non-preferred femto cell base station. Further, the mobile device can aggressively associate with a preferred femto cell base station given that services on the preferred femto cell base station can be enhanced (e.g., the preferred femto cell base station can be associated with preferential billing for the mobile device, . . . ). Moreover, the mobile device can refrain from handing off from a preferred femto cell base station even when a pilot from the preferred femto cell base station is weaker than other pilots (e.g., from non-preferred femto cell base station(s), macro cell base station(s), . . . ) so long as effective services can be supported on the preferred femto cell base station.

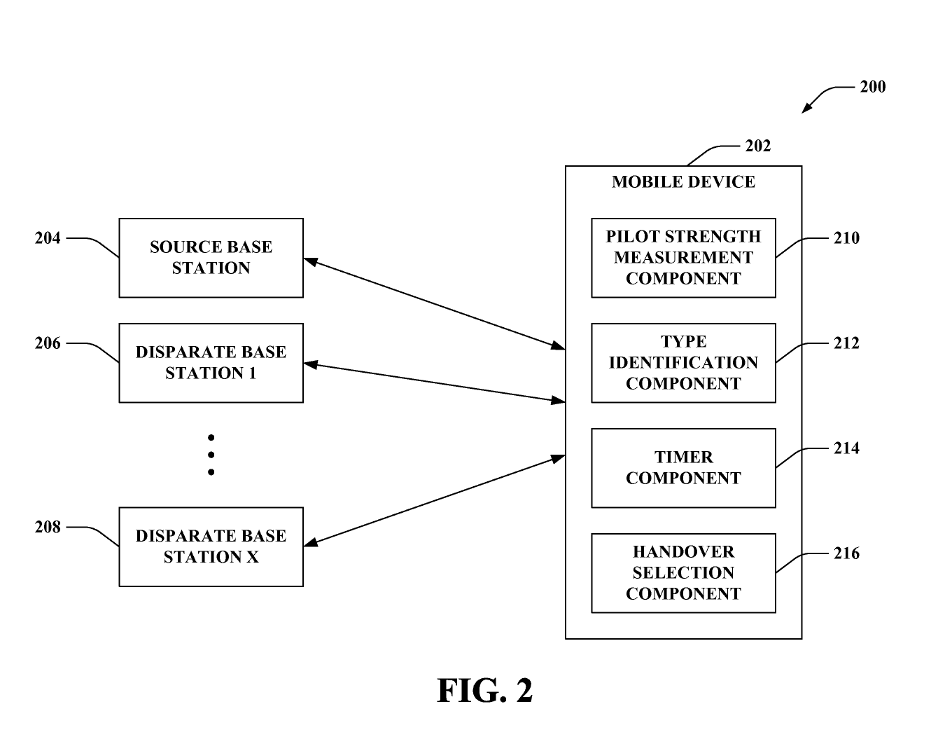

Referring to FIG. 2, illustrated is a system 200 that employs a linger timer in connection with idle handoff in a wireless communication environment. System 200 includes a mobile device 202 that can transmit and/or receive information, signals, data, instructions, commands, bits, symbols, and the like. Mobile device 202 can communicate with a source base station 204 via the forward link and/or the reverse link. Source base station 204 can transmit and/or receive information, signals, data, instructions, commands, bits, symbols, and the like. Source base station 204 can be any type of base station (e.g., femto cell base station, pico cell base station, micro cell base station, macro cell base station, . . . ). Further, system 200 can include any number of disparate base station(s) (e.g., disparate base station 1 206, . . . , disparate base station X 208, where X can be substantially any integer); disparate base station(s) 206-208 can each be substantially similar to source base station 204. It is to be appreciated that disparate base station(s) 206-208 can each be any type of base station (e.g., femto cell base station, pico cell base station, micro cell base station, macro cell base station, . . . ). Moreover, although not shown, it is contemplated that any number of mobile devices similar to mobile device 202 can be included in system 200.

Mobile device 202 can be camped on source base station 204. Further, while in idle mode, mobile device 202 can effectuate a search for pilot(s) sent from disparate base station(s) 206-208 located nearby. As described in more detail herein, based at least in part upon pilot(s) received as part of the search (e.g., discovered pilot(s), pilot(s) from source base station 204 and/or disparate base station(s) 206-208, . . . ), mobile device 202 can select to handoff to a particular one of disparate base station(s) 206-208.

Mobile device 202 can include a pilot strength measurement component 210 that can evaluate a signal quality of each received pilot (e.g. pilot(s) can be received from one or more of source base station 204, disparate base station 1 206, . . . , disparate base station X 208, . . . ). According to an example, pilot strength measurement component 210 can measure a strength associated with each obtained pilot. By way of a further example, pilot strength measurement component 210 can analyze the signal quality of a received pilot as being a received pilot strength over a total received signal strength; following this example, pilot strength measurement component 210 can measure a received pilot signal strength (Ecp) and a total signal strength (Io) on a carrier to derive a signal quality (Ecp/Io) for each received pilot. It is to be appreciated, however, that any other types of measurements related to pilots are intended to fall within the scope of the hereto appended claims.

Moreover, mobile device 202 can include a type identification component 212 that can detect whether each received pilot corresponds to a femto cell base station or a macro cell base station (e.g., whether each received pilot was sent by a femto cell base station or a macro cell base station, whether each received pilot is a femto pilot or a macro pilot, . . . ). Thus, when a pilot is obtained by mobile device 202 from disparate base station 1 206, type identification component 212 can decipher whether disparate base station 1 206 is a femto cell base station or a macro cell base station. For example, type identification component 212 can discern between the pilot being a macro pilot and a femto pilot in a given region by utilizing a preferred user zone list (PUZL), a femto neighbor list message (FNLM), and/or any other learning technique.

Mobile device 202 can also include a timer component 214 that implements a linger timer. The linger timer can be utilized to measure a time duration during which mobile device 202 is within a coverage area of a femto cell base station. According to an example, timer component 214 can initiate the linger timer upon receiving a pilot from a femto cell base station (e.g., as discerned by type identification component 212, . . . ) with a signal quality detected by pilot strength measurement component 210 to be above an entry threshold (e.g., the detected signal quality associated with the femto cell base station can signify that the femto cell base station is suitable for reselection, . . . ). For instance, mobile device 202 can resume discontinuous reception (DRX) activities during a period of time associated with the linger timer. Further, upon expiration of the linger timer as controlled by timer component 214, mobile device 202 can evaluate whether to perform an idle handoff to the femto cell base station associated with the received pilot based upon one or more subsequent measurements of signal quality for such pilot.

Timer component 214 can implement a linger timer when selecting whether to handoff to a femto cell base station (e.g., one of disparate base stations 206-208, . . . ), while timer component 214 need not employ a linger timer when evaluating whether to handoff to a macro cell base station (e.g., one of disparate base stations 206-208 to which mobile device 202 can select to handoff, . . . ). A linger timer can be implemented by timer component 214 when handing off from a macro cell base station (e.g. source base station 204 is a macro cell base station, . . . ). However, lingering need not be applied when handing off from one femto cell base station to another femto cell base station when such femto cell base stations belong to a common network (e.g., traditional idle handoff procedures can be used when moving across femto cell base stations that are both included in a common campus wide network, . . . ). Thus, if mobile device 202 is currently camped on a preferred femto cell base station (e.g., source base station 204, . . . ), timer component 214 need not provide a linger timer to be used in connection with handing off to a nearby preferred femto cell base station. Rather, if the nearby preferred femto cell base station (e.g., one of disparate base stations 206-208, . . . ) is associated with a pilot with higher signal quality as compared to a pilot from preferred femto cell source base station 204, then mobile device 202 can handoff to the nearby preferred femto cell base station without utilizing a linger timer.

Use of the linger timer implemented by timer component 214 can enable avoiding selection of a femto cell base station and subsequent registration for pedestrian and vehicular mobility. Accordingly, ping-pong selection between a macro cell base station and a femto cell base station can be mitigated, thereby improving standby time of mobile device 202 and lowering unnecessary network traffic.

By way of example, a length of time for the linger timer set by timer component 214 can be less than three minutes (e.g., less than 180 seconds, between 60 seconds and 180 seconds, one minute, . . . ); however, it is contemplated that the claimed subject matter is intended to cover any length of time for the linger timer. Further, the length of time for the linger timer can be preset, dynamically determined, configurable (e.g., by an operator, . . . ), and so forth. Moreover, the length of time for the linger timer can be fixed, varied for entering a given femto cell base station at different times, varied for entering different femto cell base stations, or the like. Pursuant to another example, the linger timer managed by timer component 214 can correspond to a series of sampling times; thus, a series of N samples of pilot quality can be yielded by pilot strength measurement component 210 as controlled by timer component 214, where N can be substantially any integer.

The linger timer provided by timer component 214 can be applied on a pilot by pilot basis, for example. Following this example, if multiple pilots from multiple femto cell base stations (e.g., plurality of disparate base stations 206-208, . . . ) are each recognized as being above an entry threshold, then a respective linger timer for each of the multiple pilots can be leveraged. Upon expiration of one of the linger timers, mobile device 202 can evaluate whether to handoff to the corresponding femto cell base station (e.g., mobile device 202 can handoff to the corresponding femto cell base station and can thereafter handoff to a disparate one of the femto cell base stations if such disparate one of the femto cell base stations has a higher signal quality, . . . ). According to another illustration, when one of the plurality of linger timers expires, mobile device 202 can wait for one or more of the other linger timers to expire prior to effectuating a handoff decision (e.g., wait for a linger timer associated with a pilot with a higher signal quality to expire prior to analyzing whether to handoff, . . . ). Pursuant to further examples, timer component 214 can apply one linger timer for all pilots, one linger timer per each type of base station (e.g., one linger timer for preferred femto cell base stations, a disparate linger timer for non-preferred femto cell base stations, . . . ), and so forth.

Further, mobile device 202 can include a handover selection component 216 that can effectuate the aforementioned evaluation of whether to perform the idle handoff from source base station 204 to the femto cell base station at the time of expiration of the linger timer. Handover selection component 216, for instance, can choose to handoff to the femto cell base station as a function of the one or more subsequent measurements of signal quality for the pilot from the femto cell base station. Further, handover selection component 216 can evaluate whether to effectuate the idle handoff based upon whether the femto cell base station is preferred or non-preferred. According to another illustration, handover selection component 216 can elect to handoff to any other type of base station from source base station 204. Moreover, handover selection component 216 can effectuate handing off to a particular one of disparate base station(s) 206-208 from source base station 204 based upon the aforementioned handoff related evaluation.

According to an example, handover selection component 216 can analyze whether to effectuate a handoff based upon a subsequent measurement of signal quality for the pilot from the femto cell base station captured at or after expiration of a linger timer. Pursuant to another example, the signal quality for the pilot from the femto cell base station can continuously be measured during a time period associated with the linger timer, and handover selection component 216 can evaluate whether to perform a handoff based upon the continuous measurements. In accordance with another example, a number of samples of the signal quality for the pilot from the femto cell base station can be collected after initiation of the linger timer (e.g., during a time period associated with the linger timer and/or at/after expiration of the linger timer, . . . ), and handover selection component 216 can analyze whether to handoff to the femto cell base station based upon the number of samples. Following this example, N samples can be obtained (e.g., with a given periodicity, within a predetermined amount of time, . . . ) and processed in substantially any manner, where N can be substantially any integer. For instance, the N samples can be averaged. Further, filtering can be applied to recognize whether at least M of the N samples are above an entry threshold, where M can be substantially any integer such that M is less than or equal to N. It is to be appreciated, however, that the claimed subject matter is not limited to the foregoing examples.

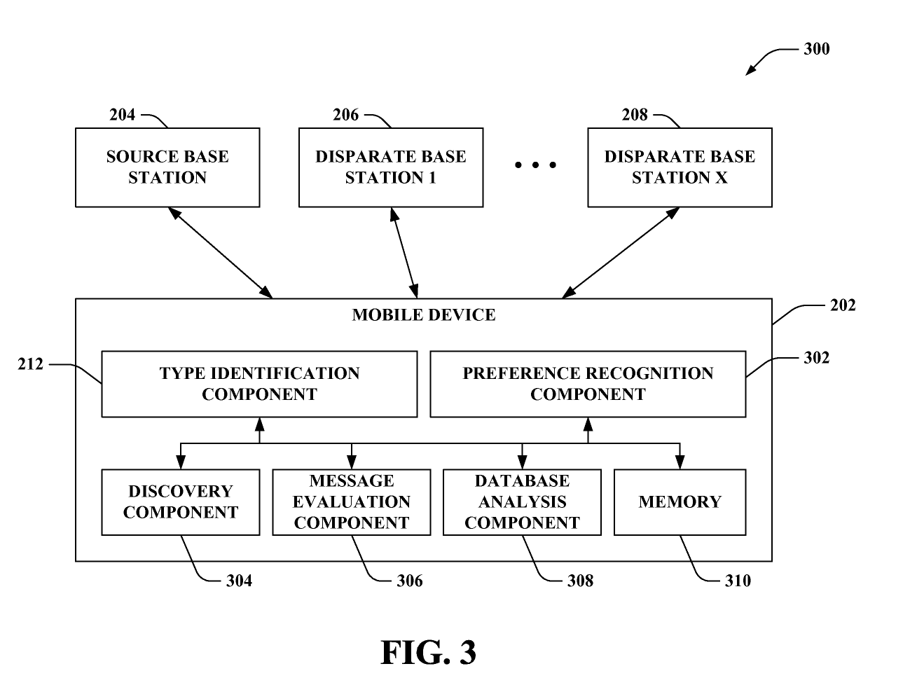

Now referring to FIG. 3, illustrated is a system 300 that facilitates recognizing base station types in a wireless communication environment. System 300 includes mobile device 202, source base station 204, and one or more disparate base stations 206-208. Mobile device 202 can search for and discover pilots from source base station 204 and/or the one or more disparate base station(s) 206-208. Mobile device 202 can further include type identification component 212, which can discern a type of base station from which each pilot is obtained. Thus, type identification component 212 can evaluate whether each pilot is from a femto cell base station or a macro cell base station.

Mobile device 202 can further include a preference recognition component 302 that can detect whether a femto cell base station is a preferred femto cell base station or a non-preferred femto cell base station. For example, mobile device 202 can encounter a pilot sent from disparate base station 1 206 and type identification component 212 can detect whether disparate base station 1 206 is a femto cell base station or a macro cell base station. Following this example and assuming that disparate base station 1 206 is recognized by type identification component 212 as a femto cell base station, then preference recognition component 302 can analyze whether disparate base station 1 206 is a preferred femto cell base station or a non-preferred femto cell base station for mobile device 202.

Pursuant to another example, a setting that regulates whether preferred femto cell base stations are differentially supported by mobile device 202 can be specified. For instance, the setting can be controlled by an operator, enabled by a user of mobile device 202, or the like. When this setting is enabled, mobile device 202 can aggressively look for preferred femto cell base stations in both horizontal and vertical neighbors. Further, thresholds that enable aggressive association with preferred femto cell base stations can be leveraged by mobile device 202 when such setting is enabled.

According to an example, type identification component 212 can detect whether a base station (e.g., source base station 204, disparate base station 1 206, . . . , disparate base station X 208, . . . ) that transmits a pilot (e.g., received by mobile device 202, . . . ) is a femto cell base station or a macro cell base station as a function of a primary synchronization code (PSC) associated with the pilot. For instance, a set of PSCs can be leveraged by base stations in a wireless communication environment. Pursuant to the aforementioned example, a subset of PSCs can be reserved for use by femto cell base stations, while other PSCs can be employed by macro cell base stations. Hence, type identification component 212 can decipher whether or not a particular PSC corresponding to the received pilot is reserved for utilization by femto cell base stations. If the particular PSC is identified as being reserved for use by a femto cell base station, then the base station from which the pilot was received can be recognized by type identification component 212 as a femto cell base station; otherwise, the base station from which the pilot was obtained can be identified by type identification component 212 as a macro cell base station. It is to be appreciated that information specifying the subset of PSCs reserved for femto cell base station utilization can be disseminated to mobile device 202 (and/or disparate mobile device(s)) via a macro broadcast, mobile device 202 can be provisioned with such information, or the like.

Mobile device 202 can further include a discovery component 304, a message evaluation component 306, a database analysis component 308, and/or memory 310. According to an illustration, type identification component 212 can leverage one or more of discovery component 304, message evaluation component 306, and/or database analysis component 308 to discern between pilots from femto cell base stations and pilots from macro cell base stations.

Discovery component 304 can enable mobile device 202 (e.g., type identification component 212, . . . ) to discover whether a base station from which a pilot is obtained is a femto cell base station or a macro cell base station by evaluating an access point identification message (APIDM) (e.g., femto identification message (FIDM), . . . ) sent by the base station. Source base station 204 and disparate base station(s) 206-208 can each transmit a respective APIDM. Discovery component 304 can receive one or more of the transmitted APIDMs and detect a respective type (e.g., macro cell base station, femto cell base station, . . . ) associated with each base station from which each APIDM is respectively obtained based upon information included in the corresponding APIDM.

Message evaluation component 306 can review a received femto neighbor list message (FNLM) to detect a type of a base station. For instance, a base station (e.g., source base station 204, disparate base station 1 206, . . . , disparate base station X 208, . . . ) can populate a femto neighbor list, which can specify femto cell base station(s) within its proximity. Further, the femto neighbor list can indicate parameters utilized by the femto cell base station(s) within its proximity. Examples of the parameters can include pseudo-noise (PN) offset, frequency, channel, and so forth. Thus, the base station can generate a FNLM that includes information concerning the femto neighbor list, and the FNLM can be transmitted to mobile device 202 (and/or any disparate mobile device(s)). Accordingly, message evaluation component 306 can analyze the received FNLM to identify parameter(s) that correspond to femto cell base station(s). Further, message evaluation component 306 can distinguish whether a pilot received from a base station (e.g., disparate base station 1 206, . . . , disparate base station X 208, . . . ) is a femto pilot or a macro pilot by comparing parameter(s) associated with the pilot to parameter(s) specified in the FNLM (or a plurality of received FNLMs).

Database analysis component 308 can evaluate a preferred user zone list (PUZL) to distinguish between a base station being a femto cell base station or a macro cell base station. PUZL can be a database retained in memory 310 that assists type identification component 212 in discerning femto cell base stations from macro cell base stations. PUZL can be provisioned to indicate available femto cell base stations within a macro zone as well as metrics to identify such femto cell base stations. According to another illustration, entries included in the PUZL retained in memory 310 can be learned by mobile device 202.

Further, it is contemplated that preference recognition component 302 can leverage one or more of discovery component 304, message evaluation component 306, and/or database analysis component 308 to distinguish between preferred femto cell base stations and non-preferred femto cell base stations. Additionally or alternatively, preference recognition component 302 can identify whether a femto cell base station is preferred or non-preferred based upon a PSC associated with a pilot obtained from the femto cell base station. For example, upon recognizing that disparate base station 1 206 (e.g., from which a pilot is received, . . . ) is a femto cell base station (e.g., as effectuated by type identification component 212, . . . ), preference recognition component 302 can utilize database analysis component 308 to evaluate a PUZL database retained in memory 310 to recognize whether disparate base station 1 206 is a preferred femto cell base station or a non-preferred femto cell base station. It is to be appreciated, however, that the claimed subject matter is not limited to the foregoing example.

Pursuant to a further example, preference recognition component 302 can detect whether a femto cell base station is preferred or non-preferred by reading a paging channel of the femto cell base station without performing idle handoff into the femto cell base station. Hence, overhead information can be read by preference recognition component 302 to distinguish whether the femto cell base station is preferred or non-preferred. Following this example, reading of the paging channel can be effectuated between sleep cycles of mobile device 202 to avoid missing pages. Thus, time periods during which mobile device 202 is not monitoring for pages from source base station 204, during which mobile device 202 commonly transitions to sleep mode, can instead be used to read paging channels of disparate base station(s) 206-208 to collect information used by preference recognition component 302 to differentiate between preferred and non-preferred femto cell base stations. According to an illustration, mobile device 202 can utilize a single receiver to obtain pages from source base station 204, upon which mobile device 202 is currently camped, as well as disparate base station(s) 206-208; yet, the claimed subject matter is not so limited. Further, reading the broadcast information prior to performing idle handoff for a potential preferred femto cell base station can mitigate preferred femto cell base station misdetection. In accordance with a further example, a call initiated by mobile device 202 can abandon the foregoing operation. Moreover, APIDM transmission (e.g., FIDM transmission, . . . ) can be coordinated to account for concurrency issues associated with reading 1X and DO paging slots (e.g., hybrid mode operation can be leveraged to read information of potential pilots in the neighborhood, 1X or DO can potentially be read to obtain the same information such as the same APIDM, . . . ).

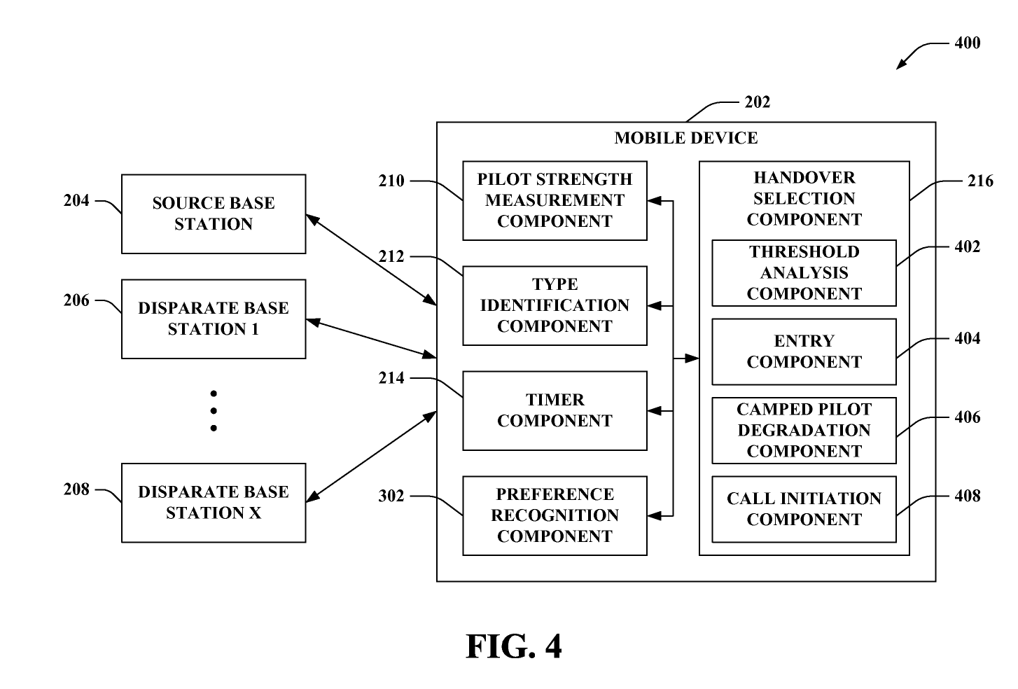

Turning to FIG. 4, illustrated is a system 400 that enables a mobile device (e.g., mobile device 202, . . .) to handoff to a disparate base station (e.g., one of disparate base station(s) 206-208, . . .) from a source base station (e.g., source base station 204, . . . ) by leveraging a linger timer in a wireless communication environment. Mobile device 202 can include pilot strength measurement component 210, type identification component 212, timer component 214, handover selection component 216, and preference recognition component 302 as described herein.

Mobile device 202 can be camped on source base station 204. While camped on source base station 204, mobile device 202 can discover pilots from disparate base stations 206-208. Upon obtaining the pilots, pilot strength measurement component 210 can evaluate respective signal qualities of each of the pilots. Moreover, type identification component 212 can identify whether each pilot is a femto pilot or a macro pilot (e.g., whether the corresponding one of disparate base stations 206-208 from which a given pilot was respectively sent is a femto cell base station or a macro cell base station, . . . ).

Handover selection component 216 can include a threshold analysis component 402 that compares a signal quality of a pilot to an entry threshold. Based upon the comparison, handover selection component 216 can identify a base station from which the pilot was obtained as a likely candidate as a target for handoff. For instance, when threshold analysis component 402 recognizes that a signal quality of a particular pilot from a femto cell base station exceeds an entry threshold, timer component 214 can initiate a linger timer corresponding to the particular pilot (e.g., without handing off to the femto cell base station corresponding to the particular pilot at a time that threshold analysis component 402 compares the signal quality to the entry threshold, . . . ). After expiration of a period of time associated with the linger timer, handover selection component 216 can evaluate whether to handoff to the femto cell base station associated with the particular pilot. Moreover, until expiration of the period of time associated with the linger timer, mobile device 202 can remain camped on source base station 204.

According to an example, threshold analysis component 402 can leverage the same entry threshold regardless of a type of a base station from which the pilot was transmitted or whether the base station is preferred or non-preferred (e.g., a common entry threshold can be used for preferred femto cell base stations, non-preferred femto cell base stations, macro cell base stations, . . . ). By way of another example, threshold analysis component 402 can utilize different entry thresholds that can depend upon the type of the base station that transmitted the pilot and/or whether such base station is preferred or non-preferred (e.g., differing entry thresholds can be used for a preferred femto cell base station versus a non-preferred femto cell base station, differing entry thresholds can be utilized for a femto cell base station versus a macro cell base station, . . . ). Hence, following this example, threshold analysis component 402 can apply an appropriate entry threshold corresponding to a base station type for a pilot recognized by type identification component 212 and/or whether the base station is preferred or non-preferred as identified by preference recognition component 302.

Moreover, handover selection component 216 can include an entry component 404 that can select whether to effectuate a handoff to the base station upon expiration of the period of time associated with the linger timer. According to an example, when the linger timer expires, entry component 404 can choose to handoff to a preferred femto cell base station (e.g. one of disparate base station 1 206, . . . , disparate base station X 208 identified as being a femto cell base station by type identification component 212 and preferred for mobile device 202 by preference recognition component 302, . . . ) so long as a signal quality of the pilot from the preferred femto cell base station is above the entry threshold (e.g., as evaluated by pilot strength measurement component 210, . . . ) at or after expiration of the linger timer. Following this example, entry component 404 can select to handoff to the preferred femto cell base station irrespective of signal qualities of pilots from source base station 204 or other neighboring base stations (e.g., disparate base station(s) 206-208 other than the preferred femto cell base station to which mobile device 202 hands off, . . . ).

Pursuant to another example, entry component 404 can evaluate idle handoff conditions to select whether to handoff to a non-preferred femto cell base station (e.g., one of disparate base station 1 206, . . . , disparate base station X 208 identified as being a femto cell base station by type identification component 212 and non-preferred for mobile device 202 by preference recognition component 302, . . . ) when the linger timer associated therewith expires. Upon entry component 404 recognizing that the idle handoff conditions are met, mobile device 202 can enter the non-preferred femto cell base station. Similarly, entry component 404 can analyze idle handoff conditions when evaluating whether to handoff to a macro cell base station (e.g., one of disparate base station 1 206, . . . , disparate base station X 208 identified as being a macro cell base station by type identification component 212, . . . ). Thus, idle handoff conditions (e.g., idle handoff criteria, current idle handoff thresholds for macro cell base stations and non-preferred femto cell base stations, . . . ) can be leveraged by entry component 404 when selecting whether to enter a non-preferred femto cell base station or a macro cell base station, while entry component 404 need not consider idle handoff conditions when evaluating whether to enter a preferred femto cell base station (e.g., mobile device 202 can enter a preferred femto cell base station after expiration of the linger timer without considering the idle handoff conditions based upon a comparison of the signal quality of a pilot from the femto cell base station and the entry threshold, . . . ).

An idle handoff condition considered by entry component 404 can be neighbor type (e.g., associated with disparate base stations 206-208, . . . ). For instance, examples of neighbor types can include a cheap neighbor (e.g., neighbor for which overhead information is available, . . . ), an expensive neighbor (e.g., neighbor for which overhead information is not available, . . . ), and a registration neighbor (e.g., mobile device 202 performs registration on transition to such a neighbor, . . . ). Moreover, entry component 404 can account for additional neighbor types related to preferred and non-preferred femto cell neighbors.

According to an example, source base station 204 can be a macro cell base station and mobile device 202 can obtain a pilot from a non-preferred femto cell base station (e.g., one of disparate base stations 206-208, . . . ). Pilot strength measurement component 210 can measure a signal quality of the pilot as being above an entry threshold, type identification component 212 can recognize the pilot as originating from a femto cell base station, and preference recognition component 302 can identify that the femto cell base station is non-preferred. Upon measuring that the signal quality exceeds the entry threshold (e.g., as evaluated by threshold analysis component 402, . . . ), timer component 214 can start a linger timer. When the linger timer expires, entry component 404 can evaluate an idle handoff condition; in particular, entry component 404 can analyze whether the signal quality of the pilot from the non-preferred femto cell base station exceeds a signal quality of a pilot from source base station 204 (e.g., the macro cell base station, . . . ) by at least 3 dB (or any other hysteresis level). If the signal quality of the pilot from the non-preferred femto cell base station is greater than the signal quality of the pilot from source base station 204 by at least 3 dB, then entry component 404 can cause mobile device 202 to enter the non-preferred femto cell base station. Under such a scenario, the non-preferred femto cell base station can be entered to mitigate missing pages while on the macro cell base station. It is to be appreciated, however, that the claimed subject matter is not limited to the aforementioned example.

Handover selection component 216 can further include a camped pilot degradation component 406. Camped pilot degradation component 406 can identify that a signal quality associated with a pilot from source base station 204, upon which mobile device 202 is currently camped, deteriorates below a predetermined level. Accordingly, camped pilot degradation component 406 can cause the linger timer set by timer component 214 to be ignored. By disabling the linger timer, handover selection component 216 can handoff to a target base station (e.g., one of disparate base station(s) 206-208, . . . ) without delay when signal quality from source base station 204 degrades below a minimum threshold level and becomes unsuitable for service for mobile device 202.

Pursuant to another example, handover selection component 216 can include a call initiation component 408 that can disable the linger timer when mobile device 202 originates a call within vicinity of a preferred femto cell base station (e.g., one of disparate base station(s) 206-208, . . . ). Prior to initiating the call, mobile device 202 can be camped on a macro cell base station (e.g., source base station 204, . . . ). Calls placed by mobile device 202 while on the preferred femto cell base station can be preferential billed (e.g. free, included in a flat fee, . . . ) as compared to calls placed by mobile device 202 while on the macro cell base station. Hence, when mobile device 202 is within vicinity of a preferred femto cell base station (e.g., one of disparate base station(s) 206-208, . . . ) with a signal quality measured by pilot strength measurement component 210 above an entry threshold (e.g., recognized by threshold analysis component 402, call initiation component 408 can enable entering the preferred femto cell base station to place a call to be initiated by mobile device 202 without waiting for expiration of the linger timer. Thus, by employing call initiation component 408, mobile device 202 need not initiate a call on a macro cell base station while encountering interference from the preferred femto cell base station (e.g., potentially dropping the call due to the interference, . . . ) and being billed at a higher rate for such call prior to handing off to the preferred femto cell base station. Moreover, it is contemplated that call initiation component 408 can similarly be applicable for calls that terminate at mobile device 202. According to a further example, it is to be appreciated that active call hand-ins can be supported to capitalize on femto cell base station availability for a call originated by or terminated at mobile device 202 and established over a macro network.

According to an example, during idle mode search, mobile device 202 can encounter a pilot from a particular femto cell base station (e.g., one of disparate base stations 206-208, . . . ) associated with a highest rank (e.g., strongest pilot, highest signal quality, etc. as measured by pilot strength measurement component 210, . . . ), which is suitable for reselection. Thus, timer component 214 can set a linger timer for a period of time (e.g., mobile device 202 can resume DRX cycle activities during this period of time, . . . ). Further, if the pilot from the particular femto cell base station still ranks highest after expiration of the linger timer (e.g. as measured by pilot strength measurement component 210, . . . ), entry component 404 can enable reselecting the particular femto cell base station. According to another example, entry component 404 can employ a filtering algorithm where N samples of pilot strengths/signal qualities can be collected by pilot strength measurement component 210 during the period of time associated with the linger timer, and the particular femto cell base station can be reselected so long as the pilot from the particular femto cell base station ranks highest for at least M of the N samples, where M and N are each integers and M is less than or equal to N. It is to be appreciated, however, that the claimed subject matter is not limited to the foregoing examples.

By way of another example, threshold analysis component 402 can identify that a signal quality of a particular pilot from a given femto cell base station (e.g., one of disparate base stations 206-208, . . . ) exceeds an entry threshold. Based thereupon, timer component 214 can start a linger timer. Following this example, if the signal quality for the particular pilot drops below the entry threshold (e.g., if continuous measurement of the signal quality of the particular pilot is employed, . . . ) while the linger timer is running, then timer component 214 can stop the linger timer and the selection of the given femto cell base station can be cancelled (e.g., by entry component 404, . . . ) until its coverage quality goes above the entry threshold again. For instance, timer component 214 can pause the linger timer until the signal quality exceeds the entry threshold. According to another illustration, timer component 214 can restart the linger timer to an initial length of time. Again, it is to be appreciated that the claimed subject matter is not limited to the aforementioned examples.

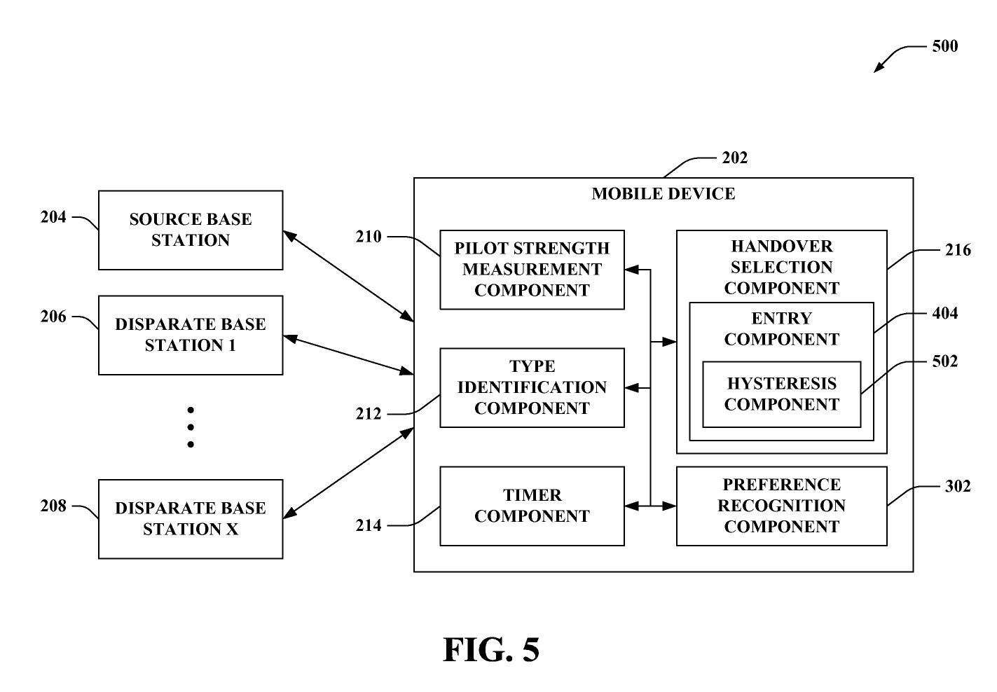

Referring to FIG. 5, illustrated is a system 500 that enables a mobile device (e.g., mobile device 202, . . . ) to remain associated with a preferred femto cell base station (e.g., source base station 204, . . . ) in preference to disparate base stations 206-208 (e.g., non-preferred femto cell base station, macro cell base station, . . . ) in a wireless communication environment. System 200 includes mobile device 202 which can be associated with source base station 204. According to an example, source base station 204 can be a preferred femto cell base station (e.g., as recognized by type identification component 212 and preference recognition component 302, . . . ). Moreover, disparate base stations 206-208 can be within proximity of mobile device 202.

Mobile device 202 can remain associated with the preferred femto cell base station (e.g., source base station 204, . . . ) as long as effective paging and traffic operation can be handled on the preferred femto cell base station. According to an example, regardless of signal qualities of pilots from disparate base stations 206-208 (e.g., neighboring macro cell base station(s), non-preferred femto cell base station(s), . . . ) as monitored by pilot strength measurement component 210, handover selection component 216 (e.g., entry component 404, . . . ) can cause mobile device 202 to remain associated with the preferred femto cell base station. Thus, priority for preferred femto cell base stations can be supported; for instance, once associated with the preferred femto cell base station, mobile device 202 can remain on the preferred femto cell base station as long as the preferred femto cell base station remains above a drop threshold (e.g., −16 dB, Tdrop threshold, . . . ), thereby enabling sticky associated with the preferred femto cell base station. Further, thresholds used by handover selection component 216 in general can allow for aggressive association with preferred femto cell base stations.

Entry component 404 can further include a hysteresis component 502 that implements a hysteresis level to be employed when evaluating whether to handoff from source base station 204. Thus, entry component 404 can select whether to handoff from source base station 204 to a particular one of disparate base stations 206-208 as a function of signal quality of a pilot from the particular one of disparate base stations 206-208, signal quality of a pilot from source base station 204, and the hysteresis level. By way of example, entry component 404 can compare the signal quality of the particular one of disparate base stations 206-208 to the signal quality of source base station 204 plus the hysteresis level supplied by hysteresis component 502. Entry component 404 can select to register with the particular one of disparate base stations 206-208 when the signal quality of the particular one of disparate base stations 206-208 exceeds the signal quality of source base station 204 plus the hysteresis level; otherwise, entry component 404 can cause mobile device 202 to remain associated with source base station 204.

A hysteresis level utilized by hysteresis component 502 can be a function of a type of source base station 204. For instance, the hysteresis level when camped on a macro cell base station can be 3 dB, while the hysteresis level when camped on a femto cell base station can be 6 dB. Further, it is contemplated that a preferred femto cell base station and a non-preferred femto cell base station can be associated with differing hysteresis levels. By leveraging differing hysteresis levels provided by hysteresis component 502, thresholds for entering and leaving a preferred femto cell base station can be different, which enables mobile device 202 to remain associated with the preferred femto cell base station so long as valid service can be provided to mobile device 202.

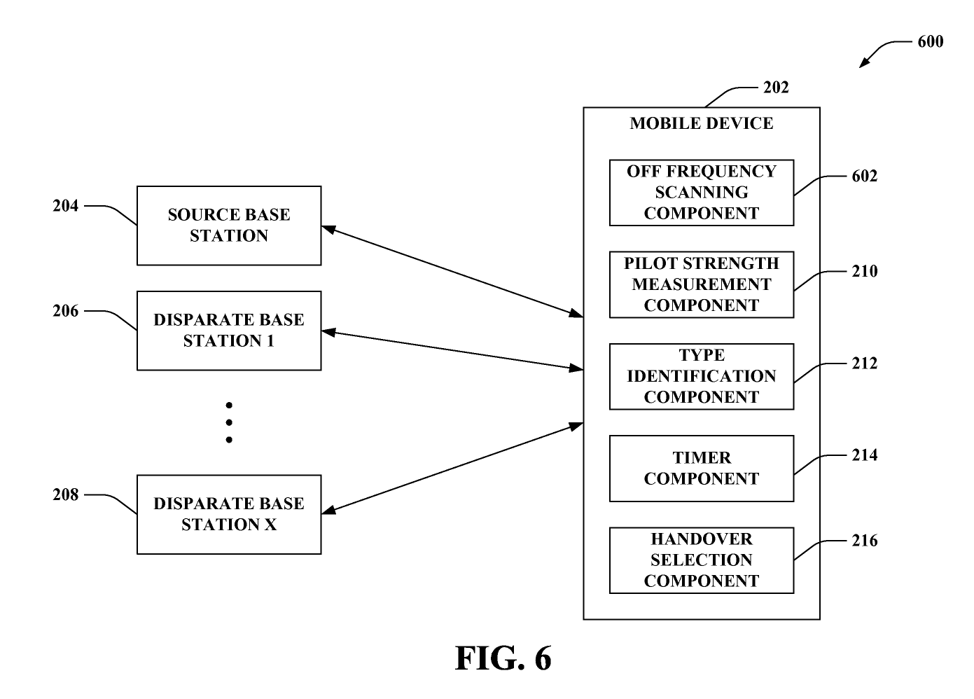

Turning to FIG. 6, illustrated is a system 600 that performs off frequency scans (OFSs) in connection with idle handoff procedures in a wireless communication environment. System 600 includes mobile device 202, source base station 204, and disparate base station(s) 206-208. As described herein, mobile device 202 can include pilot strength measurement component 210, type identification component 212, timer component 214, and handover selection component 216.

Mobile device 202 can further include an off frequency scanning component 602 that can effectuate off frequency scans to discover pilot(s) from disparate base station(s) 206-208 on channel(s) other than a channel associated with source base station 204 when multiple channels of operation are employed within a given geographic region. Off frequency scanning component 602, for example, can perform an off frequency scan based upon an indication included in a received femto neighbor list message (FNLM); following this example, the FNLM can specify that a preferred femto cell base station is located nearby and operates on a given channel.

Moreover, the FNLM can include a value for a Femto_Preferred parameter set to TRUE (e.g., as discerned by off frequency scanning component 602, . . . ) when mobile device 202 is to execute scans for off frequency femto cell base station neighbors, and a value for the Femto_Preferred parameter set to FALSE (e.g., as recognized by off frequency scanning component 602, . . . ) when mobile device 202 is not to run such off frequency scans. When Femto_Preferred is set to FALSE, mobile device 202 can skip running an off frequency scan for non-preferred femto cell base stations; hence, under such a scenario, mobile device 202 can use FNLM to find horizontal neighbors. Moreover, when Femto_Preferred is set to TRUE, mobile device 202 can look for horizontal and vertical femto neighbors (e.g., non-preferred femto cell base stations, . . . ) based on information provided in the FNLM. Further, upon current system deterioration, mobile device 202 can treat femto off frequency neighbors as macro off frequency neighbors and execute off frequency scans similar to running macro off frequency scans.

Pursuant to a further example, off frequency scanning component 602 can periodically scan for off frequency pilots; thus, for instance, off frequency scanning component 602 can execute an off frequency scan for preferred femto cell base stations once every N_{OFSFemtoNeighbor} wakeup cycles (e.g., when in a zone of a preferred femto cell base station, . . . ), where N_{OFSFemtoNeighbor} can be substantially any integer greater than or equal to 1. According to another example, off frequency scanning component 602 can effectuate an off frequency scan when pilots in a current frequency fall below a certain threshold and there is at least one off frequency pilot transmitted in the current channel indicating that there is at least one potential off frequency neighbor to which mobile device 202 can possibly handoff.

Various other aspects can be associated with the subject matter described herein. According to an example, when a mobile device (e.g. mobile device 202, . . . ) is associated with a 1X femto cell base station, various possible configurations can be used to handle EV-DO systems. For instance, a 1X femto cell base station can operate with no associated EV-DO system. Pursuant to another illustration, hybrid mode can be supported with a 1X femto cell base station and an EV-DO macro cell base station. By way of another example, hybrid mode can be supported with a 1X femto cell base station and an EV-DO femto cell base station. It is to be appreciated, however, that the claimed subject matter is not limited to the foregoing.

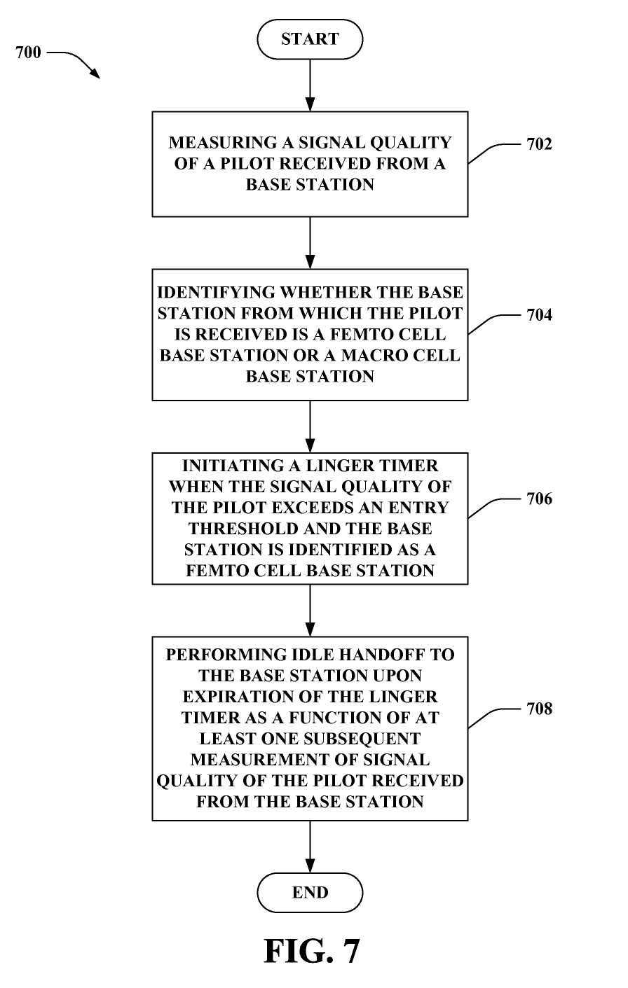

Referring to FIGS. 7-9, methodologies relating to effectuating enhanced idle handoff procedures in connection with a femto cell base station in a wireless communication environment are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 7, illustrated is a methodology 700 that facilitates evaluating whether to effectuate an idle handoff in a wireless communication environment. At 702, a signal quality of a pilot received from a base station can be measured. For instance, the signal quality can be a strength of the pilot. According to another illustration, the signal quality can be a received strength of the pilot over a total received signal strength on a carrier. Pursuant to an example, the pilot can be received by a mobile device from a neighbor base station while the mobile device is associated with (e.g., camped on, . . . ) a source base station. Further, it is contemplated that respective signal qualities of a plurality of received pilots from a plurality of neighbor base stations can be measured.

At 704, an identification can be effectuated concerning whether the base station from which the pilot is received is a femto cell base station or a macro cell base station. For instance, base station type can be discerned based upon a preferred user zone list (PUZL), a femto neighbor list message (FNLM), an access point identification message (APIDM), a primary synchronization code (PSC), a combination thereof, and so forth. Moreover, if the base station is identified as being a femto cell base station, then the femto cell base station can be recognized as being either preferred or non-preferred. For example, whether the femto cell base station is a preferred femto cell base station or a non-preferred femto cell base station can be discerned by reading a paging channel of the femto cell base station without performing idle handoff. Following this example, the paging channel of the femto cell base station can be read between sleep cycles to avoid missing pages.

At 706, a linger timer can be initiated when the signal quality of the pilot exceeds an entry threshold and the base station is identified as a femto cell base station. According to an illustration, the linger timer can be implemented on a pilot by pilot basis; thus, a respective linger timer can be started for each received pilot associated with a corresponding signal strength above the entry threshold. By way of other examples, a common linger timer can be used for all received pilots (e.g., the common linger timer can be associated with a strongest received pilot, . . . ), a first linger timer can be utilized for preferred femto cell base stations and a second linger timer can be employed for non-preferred femto cell base stations, and so forth. During a period of time associated with the linger timer, a mobile device can remain associated with the source base station without handing off to the base station corresponding to the pilot upon which the linger timer is initiated, which is identified as a femto cell base station.

At 708, idle handoff to the base station can be performed upon expiration of the linger timer as a function of at least one subsequent measurement of signal quality of the pilot received from the base station. According to an example, one subsequent measurement of the pilot can be captured at or after expiration of the linger timer. Following this example, idle handoff to the base station can be effectuated upon expiration of the linger timer if the one subsequent measurement of the signal quality of the pilot is above the entry threshold and the base station is recognized as being a preferred femto cell base station. Further, when the base station is identified as being a non-preferred femto cell base station, at least one idle handoff condition can be evaluated upon expiration of the linger timer to detect whether to perform idle handoff to the base station if the one subsequent measurement of the signal quality of the pilot is above the entry threshold.

Pursuant to another example, the signal quality of the pilot can be continuously measured upon initiating the linger timer until expiration of the linger timer. Following this example, if the signal quality of the pilot is detected to drop below the entry threshold, the linger timer can be paused until the signal quality returns to a level that exceeds the entry threshold, restarted upon again exceeding the entry threshold, or the like.

In accordance with a further example, the signal quality of the pilot can be measured N times upon initiating the linger timer, where N can be substantially any integer. For instance, the signal quality of the pilot can be periodically monitored. Following this example, a determination whether to perform idle handoff to the base station can be effectuated at least in part upon whether an average of the N samples exceeds a threshold. Alternatively, whether idle handoff to the base station can be performed can be based at least in part upon whether at least M of the N samples are above the entry threshold, where M can be an integer that is less than or equal to N.

By way of another example, the linger timer can be ignored and idle handoff to the base station can be performed when conditions of a current pilot received from the source base station, which is currently associated with the mobile device, deteriorates below a certain level. According to another example, when within vicinity of a preferred femto cell base station and the source base station is a macro cell base station, the preferred femto cell base station can be entered to place a call to be initiated by the mobile device without waiting for expiration of the linger timer.

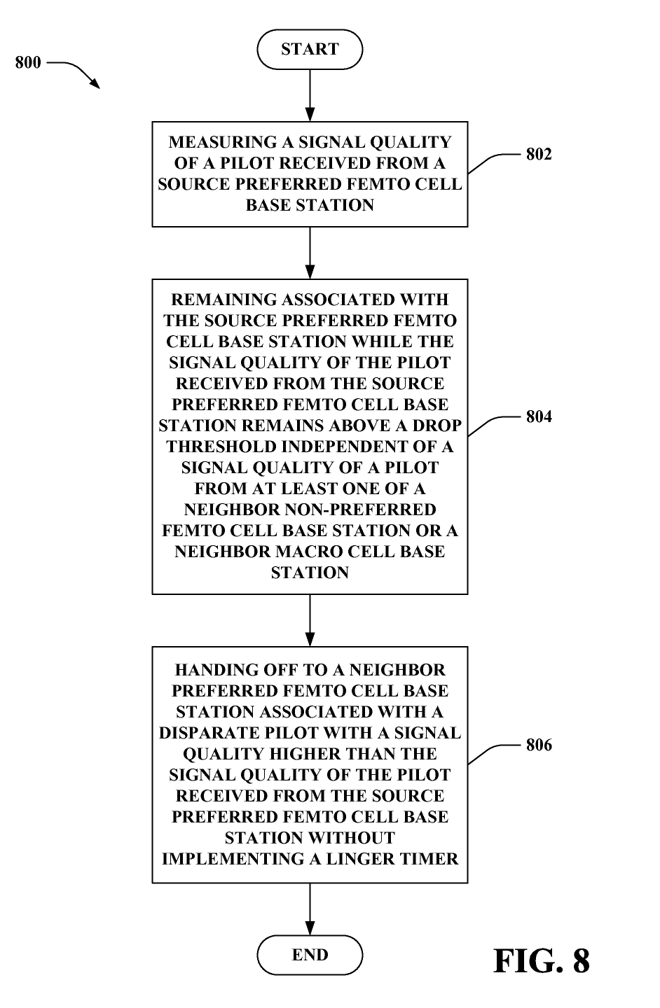

Referring now to FIG. 8, illustrated is a methodology 800 that facilitates maintaining an association with a preferred femto cell base station in a wireless communication environment. At 802, a signal quality of a pilot received from a source preferred femto cell base station can be measured. At 804, a mobile device can remain associated with the source preferred femto cell base station while the signal quality of the pilot received from the source preferred femto cell base station remains above a drop threshold independent of a signal quality of a pilot from at least one of a neighbor non-preferred femto cell base station or a neighbor macro cell base station. Thus, so long as effective paging and traffic operation can be handled on the source preferred femto cell base station, the mobile device can continue to be associated with the source preferred femto cell base station rather than handing off to a neighbor non-preferred femto cell base station or a neighbor macro cell base station. At 806, handoff to a neighbor preferred femto cell base station associated with a disparate pilot with a signal quality higher than the signal quality of the pilot received from the source preferred femto cell base station can be effectuated without implementing a linger timer.

According to an example, a mobile device can effectuate an idle handoff from a macro cell base station to a first preferred femto cell base station (e.g., as described in FIG. 7, . . . ). Once connected to the first preferred femto cell base station (e.g., the source preferred femto cell base station, . . . ), the mobile device need not apply a linger timer to handoff to a second preferred femto cell base station (e.g., the neighbor preferred femto cell base station, . . . ). Pursuant to this example, if more than one linger timer is used for preferred femto cell base stations (e.g., in accordance with methodology 700 of FIG. 7, linger timer is applied on a pilot by pilot basis, . . . ), then the mobile device can enter the first preferred femto cell base station from the macro cell base station upon expiration of a linger timer corresponding thereto even if a signal quality of the pilot from the first preferred femto cell base station is lower than a signal quality of the pilot from the second preferred femto cell base station (e.g., as long as the signal quality of the pilot from the first preferred femto cell base station exceeds the entry threshold upon expiration of the corresponding linger timer, if the linger timer associated with the second preferred femto cell base station has yet to expire when the linger timer associated with the first preferred femto cell base station expires, . . . ). Thereafter, the mobile device can handoff from the first preferred femto cell base station to the second preferred femto cell base station without delay associated with implementing the linger timer.

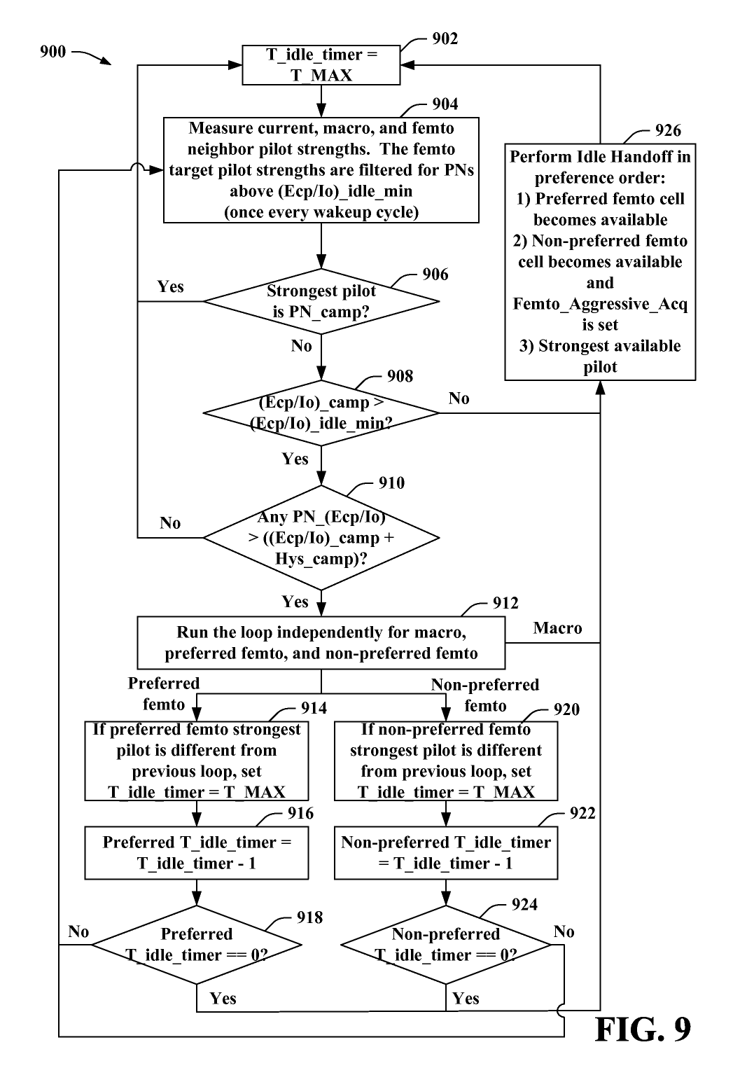

Now turning to FIG. 9, illustrated is a methodology 900 that facilitates utilizing a first linger timer for a set of preferred femto cell base stations and a second linger timer for a set of non-preferred femto cell base stations in a wireless communication environment. At 902, a linger timer (e.g., T_idle timer, . . . ) can be set to a maximum value (e.g., T MAX, . . . ). At 904, current, macro and femto neighbor pilot strengths can be measured. For instance, such measurements can be collected once every wakeup cycle. Moreover, the femto target pilot strengths can be filtered for PN offsets above a minimum threshold signal quality (e.g., (Ecp/Io)_idle_min, . . . ). (Ecp/Io)_idle_min can be a minimum Ecp/Io level below which idle handoff is triggered by disabling the linger timer (e.g., −12 dB, . . . ). At 906, it can be determined whether a PN offset of a base station that the mobile device is currently camped on (e.g., PN_camp, . . . ) is associated with a strongest pilot. If PN_camp is associated with the strongest pilot, then methodology 900 returns to 902; otherwise, methodology 900 proceeds to 908.

At 908, a signal quality (e.g., (Ecp/Io)_camp, . . . ) of the pilot associated with the base station upon which the mobile device is currently camped can be compared to the minimum threshold signal quality (e.g., (Ecp/Io)_idle_min, . . . ). If (Ecp/Io)_camp is greater than (Ecp/Io)_idle_min, then methodology 900 can continue to 910; otherwise, methodology can continue to 926 (e.g., to immediately handoff given a deteriorated signal quality associated with the base station upon which the mobile device currently camps, . . . ). At 910, signal qualities (e.g., PN_(Ecp/Io), . . . ) of pilots from base stations other than the base station upon which the mobile device is currently camped can be compared to the signal quality (e.g., (Ecp/Io)_camp, . . . ) of the pilot associated with the base station upon which the mobile device is currently camped plus a hysteresis level (e.g., Hys_camp, . . . ). The hysteresis level can be a function of a type of the base station upon which the mobile device is camped (e.g., 3 dB when camped on a macro cell base station, 6 dB when camped on a femto cell base station, . . . ). Further, if any PN_(Ecp/Io) is greater than (Ecp/Io)_camp plus Hys_camp, then methodology 900 can continue to 912; else, methodology 900 can return to 902.

At 912, the loop can be run independently for macro cell base stations, preferred femto cell base stations, and non-preferred femto cell base stations. For instance, methodology 900 can proceed to 926 for macro cell base stations. Further, for a preferred femto cell base station, methodology 900 can continue to 914. At 914, if the preferred femto cell base station with a strongest pilot is different from a previous loop of methodology 900, then a preferred femto cell base station linger timer can be set to T_MAX. At 916, the preferred femto cell base station linger timer can be decremented by 1 unit (e.g., Preferred T_idle_timer=T_idle_timer−1, . . . ). At 918, if the preferred femto cell base station linger timer equals 0, then methodology 900 continues to 926; otherwise, methodology 900 returns to 904 to run another loop. Similarly, from 912, for a non-preferred femto cell base station, methodology 900 can continue to 920. At 920, if the non-preferred femto cell base station with a strongest pilot is different from a previous loop of methodology 900, then a non-preferred femto cell base station linger timer can be set to T_MAX. At 922, the non-preferred femto cell base station linger timer can be decremented by 1 unit (e.g., Non-preferred T_idle_timer=T_idle_timer−1, . . . ). At 924, if the non-preferred femto cell base station linger timer equals 0, then methodology 900 continues to 926; otherwise, if the non-preferred femto cell base station linger timer does not equal 0, then methodology 900 returns to 904 to run another loop. At 926, idle handoff can be performed in the following preference order: 1) preferred femto cell base station becomes available; 2) non-preferred femto cell base station becomes available and Femto_Aggressive_Acq is set; 3) a strongest available pilot. If Femto_Aggressive_Acq is set, then the mobile device can execute scans for off frequency femto neighbors based on information provided in a FNLM, for instance. From 926, methodology 900 can return to 902.

It is to be appreciated, however, that the claimed subject matter is not limited to the example depicted in FIG. 9. Rather, methodology 900 is merely presented for illustration purposes, and it is contemplated that the claimed subject matter is not so limited. For instance, it is contemplated that the linger timer can be applied independently for each pilot, signal quality of pilots can be measured continuously, periodically, or upon expiration of the linger timer, and so forth.

It will be appreciated that, in accordance with one or more aspects described herein, inferences can be made regarding performing idle handoff in connection with a femto cell base station in a wireless communication environment. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences pertaining to determining a type of a base station from which a pilot is received and/or whether the base station is preferred or non-preferred (e.g., if the base station is a femto cell base station, . . . ). By way of further illustration, an inference can be made related to selecting whether to effectuate an idle handoff. It will be appreciated that the foregoing examples are illustrative in nature and are not intended to limit the number of inferences that can be made or the manner in which such inferences are made in conjunction with the various embodiments and/or methods described herein.

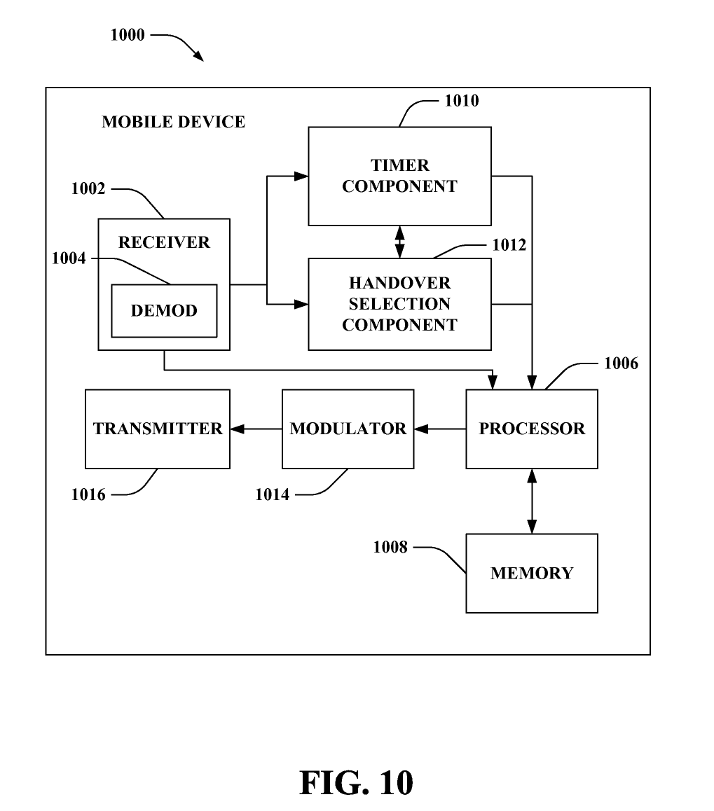

FIG. 10 is an illustration of a mobile device 1000 that evaluates whether to perform an idle handoff in a wireless communication system. Mobile device 1000 comprises a receiver 1002 that receives a signal from, for instance, a receive antenna (not shown), and performs typical actions thereon (e.g., filters, amplifies, downconverts, etc.) the received signal and digitizes the conditioned signal to obtain samples. Receiver 1002 can be, for example, an MMSE receiver, and can comprise a demodulator 1004 that can demodulate received symbols and provide them to a processor 1006 for channel estimation. Processor 1006 can be a processor dedicated to analyzing information received by receiver 1002 and/or generating information for transmission by a transmitter 1016, a processor that controls one or more components of mobile device 1000, and/or a processor that both analyzes information received by receiver 1002, generates information for transmission by transmitter 1016, and controls one or more components of mobile device 1000.

Mobile device 1000 can additionally comprise memory 1008 (e.g., memory 310, . . . ) that is operatively coupled to processor 1006 and that can store data to be transmitted, received data, and any other suitable information related to performing the various actions and functions set forth herein. Memory 1008, for instance, can store protocols and/or algorithms associated with measuring signal quality of received pilots, identifying base station types, recognizing whether a femto cell base station is preferred or non-preferred, starting and/or controlling a linger timer, and so forth. Further, memory 1008 can store protocols and/or algorithms associated with selecting whether to effectuate an idle handoff.

It will be appreciated that the data store (e.g., memory 1008) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1008 of the subject systems and methods is intended to comprise, without being limited to, these and any other suitable types of memory.

Processor 1006 can be operatively coupled to a timer component 1010 and/or a handover selection component 1012. Timer component 1010 can be substantially similar to timer component 214 of FIG. 2 and/or handover selection component 1012 can be substantially similar to handover selection component 216 of FIG. 2. Timer component 1010 can initiate a linger timer upon mobile device 1000 detecting a signal quality of a pilot from a neighbor base station that exceeds an entry threshold. Moreover, upon expiration of the linger timer, handover selection component 1012 can evaluate whether to handover to the neighbor base station based at least in part upon one or more subsequent measurements of signal quality associated with the pilot from the neighbor base station. Although not shown, it is contemplated that mobile device 1000 can further include a pilot strength measurement component (e.g., substantially similar to pilot strength measurement component 210 of FIG. 2, . . . ), a type identification component (e.g., substantially similar to type identification component 212 of FIG. 2, . . . ), a preference recognition component (e.g., substantially similar to preference recognition component 302 of FIG. 3, . . . ), a discovery component (e.g., substantially similar to discovery component 304 of FIG. 3, . . . ), a message evaluation component (e.g., substantially similar to message evaluation component 306 of FIG. 3, . . . ), a database analysis component (e.g., substantially similar to database analysis component 308 of FIG. 3, . . . ), a threshold analysis component (e.g., substantially similar to threshold analysis component 402 of FIG. 4, . . . ), an entry component (e.g., substantially similar to entry component 404 of FIG. 4, ), a camped pilot degradation component (e.g., substantially similar to camped pilot degradation component 406 of FIG. 4, . . . ), a call initiation component (e.g., substantially similar to call initiation component 408 of FIG. 4, . . . ), a hysteresis component (e.g., substantially similar to hysteresis component 502 of FIG. 5, . . . ), and/or an off frequency scanning component (e.g., substantially similar to off frequency scanning component 602 of FIG. 6, . . . ). Mobile device 1000 still further comprises a modulator 1014 and a transmitter 1016 that transmits data, signals, etc. to a base station. Although depicted as being separate from the processor 1006, it is to be appreciated that timer component 1010, handover selection component 1012 and/or modulator 1014 can be part of processor 1006 or a number of processors (not shown).

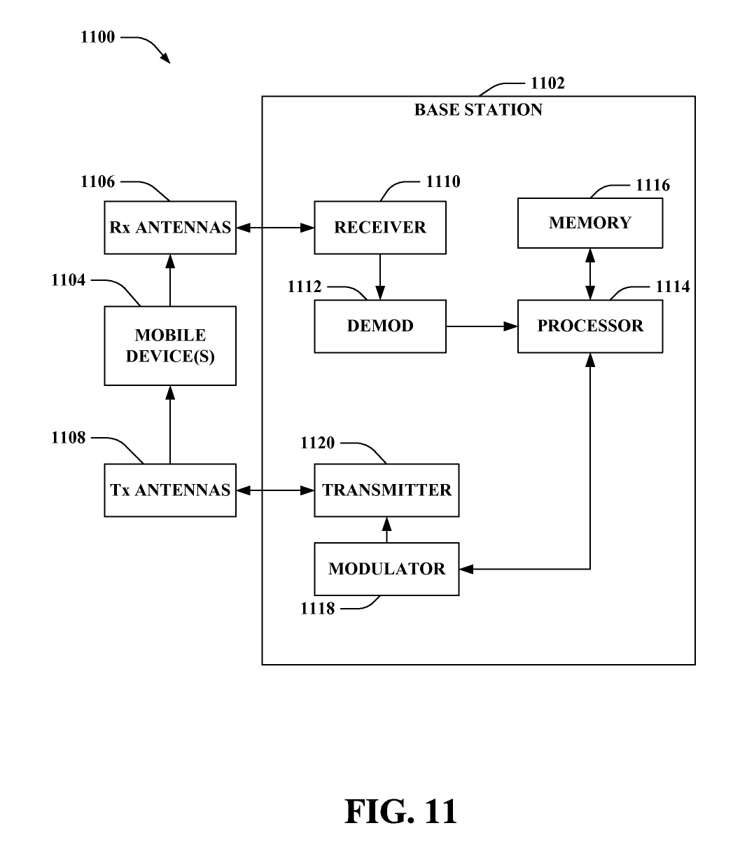

FIG. 11 is an illustration of a system 1100 that transmits pilots in a wireless communication environment. System 1100 comprises a base station 1102 (e.g., access point, . . . ) with a receiver 1110 that receives signal(s) from one or more mobile devices 1104 through a plurality of receive antennas 1 106, and a transmitter 1120 that transmits to the one or more mobile devices 1104 through a transmit antenna 1108. Receiver 1110 can receive information from receive antennas 1106 and is operatively associated with a demodulator 1112 that demodulates received information. Demodulated symbols are analyzed by a processor 1114 that can be similar to the processor described above with regard to FIG. 10, and which is coupled to a memory 1116 that stores data to be transmitted to or received from mobile device(s) 1104 and/or any other suitable information related to performing the various actions and functions set forth herein. Processor 1114 is further coupled to a modulator 1118. Modulator 1118 can multiplex a frame for transmission by a transmitter 1120 through antennas 1108 to mobile device(s) 1104 in accordance with the aforementioned description. Although depicted as being separate from the processor 1114, it is to be appreciated that modulator 1118 can be part of processor 1114 or a number of processors (not shown).

In some aspects the teachings herein may be employed in a network that includes macro scale coverage (e.g., a large area cellular network such as a 3G networks, typically referred to as a macro cell network) and smaller scale coverage (e.g., a residence-based or building-based network environment). As an access terminal (“AT”) (e.g., mobile device, . . . ) moves through such a network, the access terminal may be served in certain locations by access nodes (“ANs”) (e.g., base stations, . . . ) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node (e.g., macro cell base station, . . . ). A node that provides coverage over a relatively small area (e.g., a residence) may be referred to as a femto node (e.g., femto cell base station, . . . ). A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, macro cell base station, and so on. Also, a femto node may be configured or referred to as a Home NodeB, Home eNodeB, access point base station, femto cell, femto cell base station, and so on.

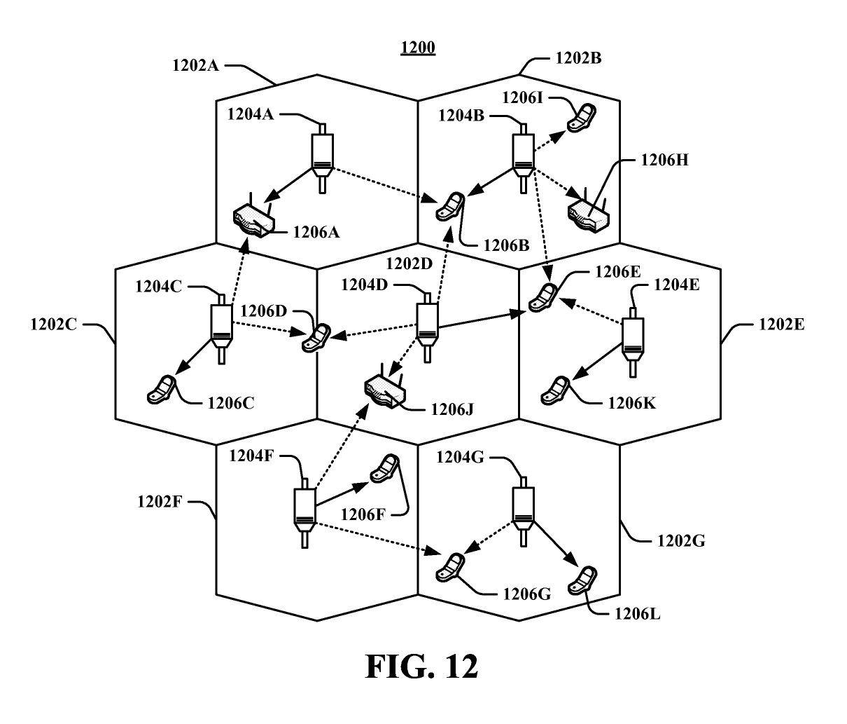

FIG. 12 illustrates a wireless communication system 1200, configured to support a number of users, in which the teachings herein may be implemented. System 1200 provides communication for multiple cells 1202, such as, for example, macro cells 1202A-1202G, with each cell being serviced by a corresponding access node 1204 (e.g., access nodes 1204A-1204G). As shown in FIG. 12, access terminals 1206 (e.g., access terminals 1206A-1206L) may be dispersed at various locations throughout the system 1200 over time. Each access terminal 1206 may communicate with one or more access nodes 1204 on a forward link (“FL”) and/or a reverse link (“RL) at a given moment, depending upon whether the access terminal 1206 is active and whether it is in soft handoff, for example. The wireless communication system 1200 may provide service over a large geographic region. For example, macro cells 1202A-1202G may cover a few blocks in a neighborhood.

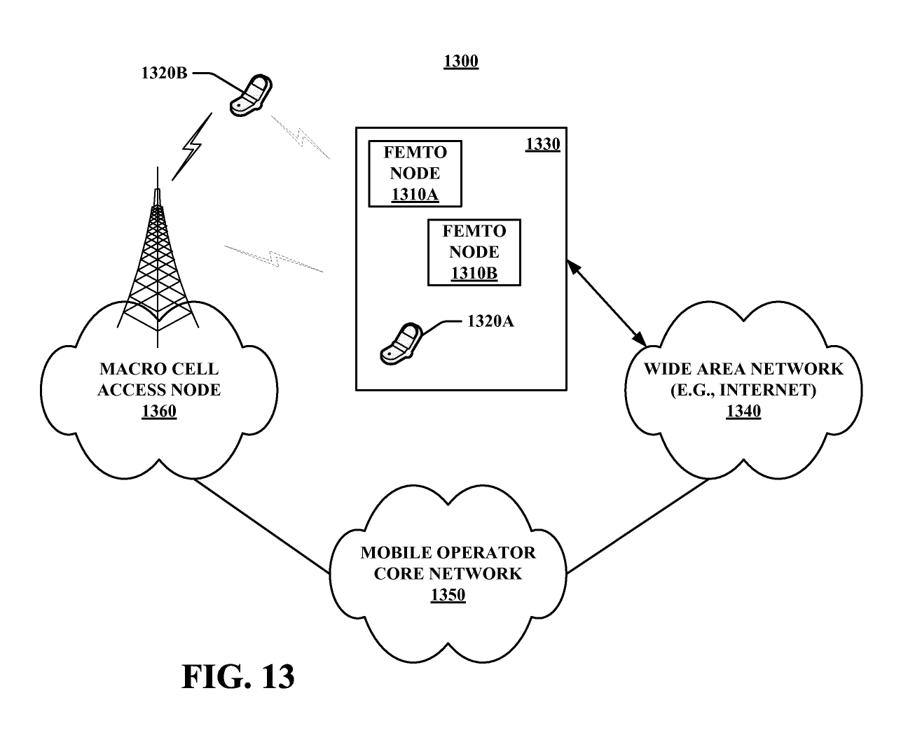

FIG. 13 illustrates an exemplary communication system 1300 where one or more femto nodes are deployed within a network environment. Specifically, system 1300 includes multiple femto nodes 1310 (e.g. femto nodes 1310A and 1310B) installed in a relatively small scale network environment (e.g., in one or more user residences 1330). Each femto node 1310 may be coupled to a wide area network 1340 (e.g., the Internet) and a mobile operator core network 1350 via a DSL router, a cable modem, a wireless link, or other connectivity means (not shown). As will be discussed below, each femto node 1310 may be configured to serve associated access terminals 1320 (e.g., access terminal 1320A) and, optionally, alien access terminals 1320 (e.g., access terminal 1320B). In other words, access to femto nodes 1310 may be restricted whereby a given access terminal 1320 may be served by a set of designated (e.g., home) femto node(s) 1310 but may not be served by any non-designated femto nodes 1310 (e.g., a neighbor's femto node 1310).

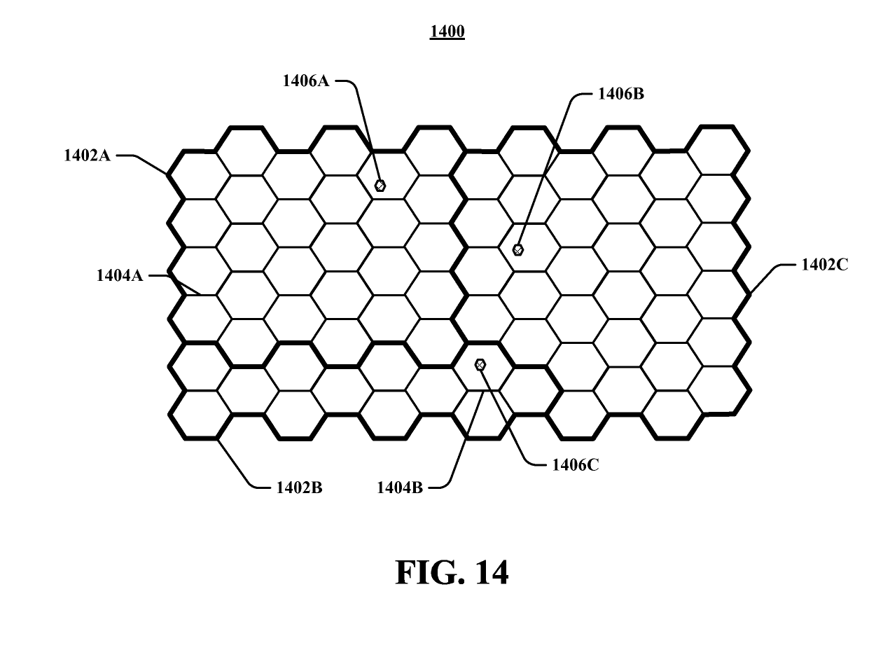

FIG. 14 illustrates an example of a coverage map 1400 where several tracking areas 1402 (or routing areas or location areas) are defined, each of which includes several macro coverage areas 1404. Here, areas of coverage associated with tracking areas 1402A, 1402B, and 1402C are delineated by the wide lines and the macro coverage areas 1404 are represented by the hexagons. The tracking areas 1402 also include femto coverage areas 1406. In this example, each of the femto coverage areas 1406 (e.g., femto coverage area 1406C) is depicted within a macro coverage area 1404 (e.g., macro coverage area 1404B). It should be appreciated, however, that a femto coverage area 1406 may not lie entirely within a macro coverage area 1404. In practice, a large number of femto coverage areas 1406 may be defined with a given tracking area 1402 or macro coverage area 1404. Also, one or more pico coverage areas (not shown) may be defined within a given tracking area 1402 or macro coverage area 1404.

Referring again to FIG. 13, the owner of a femto node 1310 may subscribe to mobile service, such as, for example, 3G mobile service, offered through the mobile operator core network 1350. In addition, an access terminal 1320 may be capable of operating both in macro environments and in smaller scale (e.g., residential) network environments. In other words, depending on the current location of the access terminal 1320, the access terminal 1320 may be served by an access node 1360 of the macro cell mobile network 1350 or by any one of a set of femto nodes 1310 (e.g., the femto nodes 1310A and 1310B that reside within a corresponding user residence 1330). For example, when a subscriber is outside his home, he is served by a standard macro access node (e.g., node 1360) and when the subscriber is at home, he is served by a femto node (e.g., node 1310A). Here, it should be appreciated that a femto node 1310 may be backward compatible with existing access terminals 1320.

A femto node 1310 may be deployed on a single frequency or, in the alternative, on multiple frequencies. Depending on the particular configuration, the single frequency or one or more of the multiple frequencies may overlap with one or more frequencies used by a macro node (e.g. node 1360).

In some aspects, an access terminal 1320 may be configured to connect to a preferred femto node (e.g., the home femto node of the access terminal 1320) whenever such connectivity is possible. For example, whenever the access terminal 1320 is within the user's residence 1330, it may be desired that the access terminal 1320 communicate only with the home femto node 13 10.

In some aspects, if the access terminal 1320 operates within the macro cellular network 1350 but is not residing on its most preferred network (e.g., as defined in a preferred roaming list), the access terminal 1320 may continue to search for the most preferred network (e.g., the preferred femto node 1310) using a Better System Reselection (“BSR”), which may involve a periodic scanning of available systems to determine whether better systems are currently available, and subsequent efforts to associate with such preferred systems. With the acquisition entry, the access terminal 1320 may limit the search for specific band and channel. For example, the search for the most preferred system may be repeated periodically. Upon discovery of a preferred femto node 1310, the access terminal 1320 selects the femto node 1310 for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 1310 that reside within the corresponding user residence 1330). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access nodes (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that authorized to access the restricted femto node. A guest access terminal may refer to an access terminal with temporary access to the restricted femto node. An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a pico node may be restricted, a home pico node may be defined for a given access terminal, and so on.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

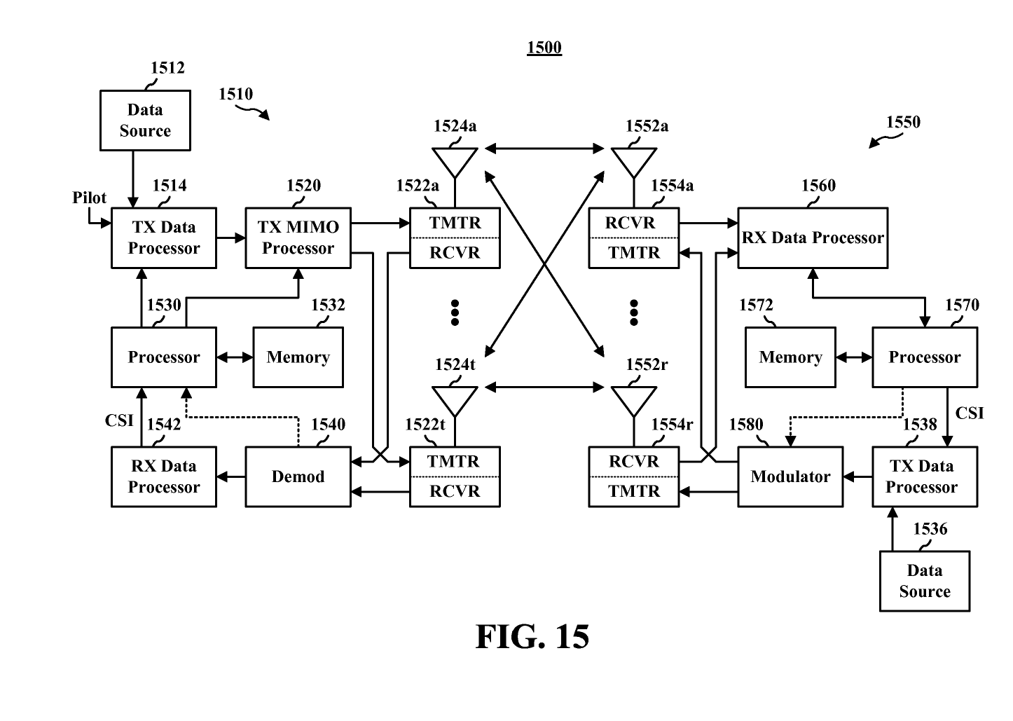

FIG. 15 shows an example wireless communication system 1500. The wireless communication system 1500 depicts one base station 1510 and one mobile device 1550 for sake of brevity. However, it is to be appreciated that system 1500 can include more than one base station and/or more than one mobile device, wherein additional base stations and/or mobile devices can be substantially similar or different from example base station 1510 and mobile device 1550 described below. In addition, it is to be appreciated that base station 1510 and/or mobile device 1550 can employ the systems (FIGS. 1-6, 10-14 and 16) and/or methods (FIGS. 7-9) described herein to facilitate wireless communication there between.

At base station 1510, traffic data for a number of data streams is provided from a data source 1512 to a transmit (TX) data processor 1514. According to an example, each data stream can be transmitted over a respective antenna. TX data processor 1514 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1550 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1530. Memory 1532 can store program code, data, and other information used by processor 1530 or other components of base station 1510.

The modulation symbols for the data streams can be provided to a TX MIMO processor 1520, which can further process the modulation symbols (e.g., for OFDM). TX MIMO processor 1520 then provides N_{T} modulation symbol streams to N_{T} transmitters (TMTR) 1522a through 1522t. In various embodiments, TX MIMO processor 1520 applies beamforming weights to the symbols of the data streams and to the antenna from which the symbol is being transmitted.

Each transmitter 1522 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1522a through 1522t are transmitted from N_{T} antennas 1524a through 1524t, respectively.

At mobile device 1550, the transmitted modulated signals are received by N_{R} antennas 1552a through 1552r and the received signal from each antenna 1552 is provided to a respective receiver (RCVR) 1554a through 1554r. Each receiver 1554 conditions (e.g., filters, amplifies, and downconverts) a respective signal, digitizes the conditioned signal to provide samples, and further processes the samples to provide a corresponding “received” symbol stream.

An RX data processor 1560 can receive and process the N_{R} received symbol streams from N_{R} receivers 1554 based on a particular receiver processing technique to provide N_{T} “detected” symbol streams. RX data processor 1560 can demodulate, deinterleave, and decode each detected symbol stream to recover the traffic data for the data stream. The processing by RX data processor 1560 is complementary to that performed by TX MIMO processor 1520 and TX data processor 1514 at base station 1510.

A processor 1570 can periodically determine which preceding matrix to utilize as discussed above. Further, processor 1570 can formulate a reverse link message comprising a matrix index portion and a rank value portion.

The reverse link message can comprise various types of information regarding the communication link and/or the received data stream. The reverse link message can be processed by a TX data processor 1538, which also receives traffic data for a number of data streams from a data source 1536, modulated by a modulator 1580, conditioned by transmitters 1554a through 1554r, and transmitted back to base station 1510.

At base station 1510, the modulated signals from mobile device 1550 are received by antennas 1524, conditioned by receivers 1522, demodulated by a demodulator 1540, and processed by a RX data processor 1542 to extract the reverse link message transmitted by mobile device 1550. Further, processor 1530 can process the extracted message to determine which preceding matrix to use for determining the beamforming weights.

Processors 1530 and 1570 can direct (e.g., control, coordinate, manage, etc.) operation at base station 1510 and mobile device 1550, respectively. Respective processors 1530 and 1570 can be associated with memory 1532 and 1572 that store program codes and data. Processors 1530 and 1570 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

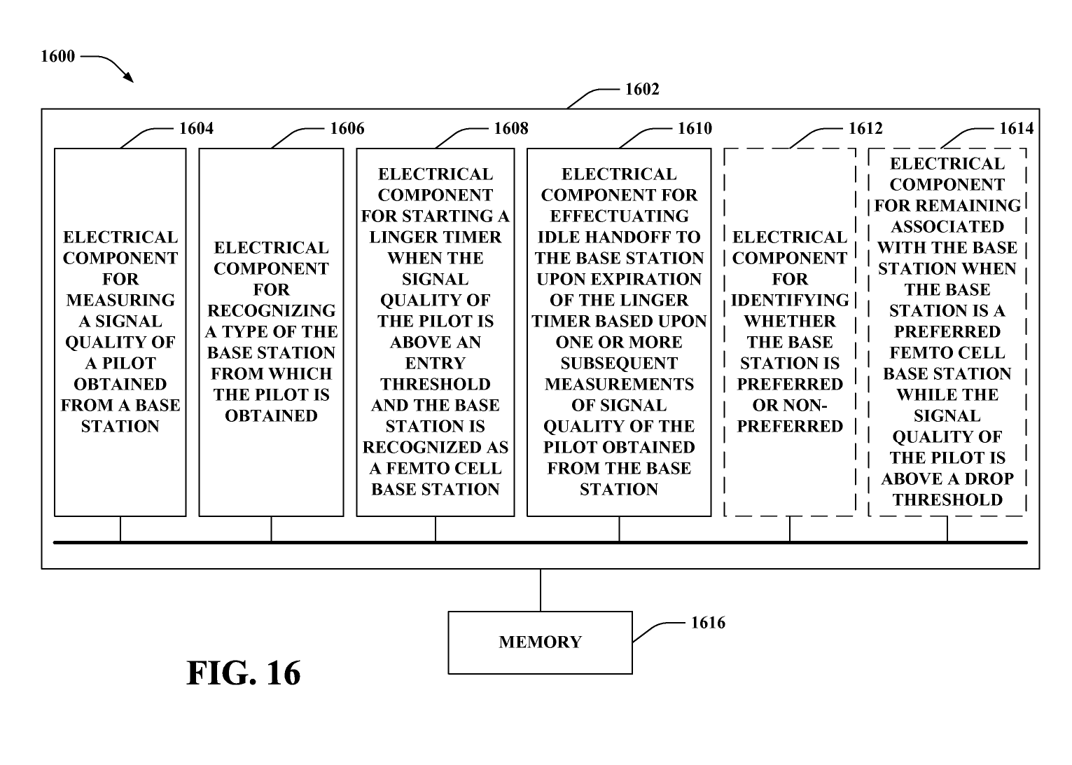

With reference to FIG. 16, illustrated is a system 1600 that enables effectuating an idle handoff in a wireless communication environment. For example, system 1600 can reside within a mobile device. It is to be appreciated that system 1600 is represented as including functional blocks, which can be functional blocks that represent functions implemented by a processor, software, or combination thereof (e.g., firmware). System 1600 includes a logical grouping 1602 of electrical components that can act in conjunction. For instance, logical grouping 1602 can include an electrical component for measuring a signal quality of a pilot obtained from a base station 1604. The pilot can be obtained from the base station while camped on a disparate source base station. Further, logical grouping 1602 can include an electrical component for recognizing a type of the base station from which the pilot is obtained 1606. For instance, the type of the base station can be a femto cell base station or a macro cell base station. Moreover, logical grouping 1602 can include an electrical component for starting a linger timer when the signal quality of the pilot is above an entry threshold and the base station is recognized as a femto cell base station 1608. Logical grouping 1602 can additionally include an electrical component for effectuating idle handoff to the base station upon expiration of the linger timer based upon one or more subsequent measurements of signal quality of the pilot obtained from the base station 1610. Logical grouping 1602 can also optionally include an electrical component for identifying whether the base station is preferred or non-preferred 1612. Moreover, logical grouping 1602 can optionally include an electrical component for remaining associated with the base station when the base station is a preferred femto cell base station while the signal quality of the pilot is above a drop threshold 1614. Additionally, system 1600 can include a memory 1616 that retains instructions for executing functions associated with electrical components 1604, 1606, 1608, 1610, 1612, and 1614. While shown as being external to memory 1616, it is to be understood that one or more of electrical components 1604, 1606, 1608, 1610, 1612, and 1614 can exist within memory 1616.

The various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g. a combination of a DSP and a microprocessor, a plurality of microprocessors, one or more microprocessors in conjunction with a DSP core, or any other such configuration. Additionally, at least one processor can comprise one or more modules operable to perform one or more of the steps and/or actions described above.

Further, the steps and/or actions of a method or algorithm described in connection with the aspects disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some aspects, the processor and the storage medium can reside in an ASIC. Additionally, the ASIC can reside in a user terminal. In the alternative, the processor and the storage medium can reside as discrete components in a user terminal. Additionally, in some aspects, the steps and/or actions of a method or algorithm can reside as one or any combination or set of codes and/or instructions on a machine readable medium and/or computer readable medium, which can be incorporated into a computer program product.

In one or more aspects, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments can be described or claimed in the singular, the plural is contemplated unless limitation to the singular is explicitly stated. Additionally, all or a portion of any aspect and/or embodiment can be utilized with all or a portion of any other aspect and/or embodiment, unless stated otherwise.

What is claimed is:

1. A method, comprising:
measuring a signal quality of a pilot received from a base station;
identifying whether the base station from which the pilot is received is a femto cell base station or a macro cell base station;
initiating a linger timer when the signal quality of the pilot exceeds an entry threshold and the base station is identified as a femto cell base station; and
performing idle handoff to the base station upon expiration of the linger timer as a function of at least one subsequent measurement of signal quality of the pilot received from the base station.

2. The method of claim 1, wherein the signal quality is a received strength of the pilot over a total received signal strength on a carrier.

3. The method of claim 1, further comprising discerning whether the base station from which the pilot is received is a femto cell base station or a macro cell base station based upon at least one of a preferred user zone list (PUZL), a femto neighbor list message (FNLM), an access point identification message (APIDM), or a primary synchronization code (PSC).

4. The method of claim 1, further comprising recognizing whether the base station is preferred or non-preferred when the base station is identified as being a femto cell base station.

5. The method of claim 4, further comprising reading a paging channel of the base station between sleep cycles to discern whether the base station is preferred or non-preferred.

6. The method of claim 1, wherein the linger timer is implemented on a pilot by pilot basis.

7. The method of claim 1, wherein a mobile device remains associated with a source base station without handing off to the base station corresponding to the pilot upon which the linger timer is initiated during a period of time associated with the linger timer.

8. The method of claim 1, further comprising capturing one subsequent measurement of the signal quality of the pilot.

9. The method of claim 8, further comprising effectuating idle handoff to the base station upon expiration of the linger timer if the one subsequent measurement of the signal quality of the pilot is above the entry threshold and the base station is recognized as being a preferred femto cell base station.

10. The method of claim 8, further comprising evaluating at least one idle handoff condition upon expiration of the linger timer to detect whether to perform idle handoff to the base station if the one subsequent measurement of the signal quality of the pilot is above the entry threshold and the base station is identified as being a non-preferred femto cell base station.

11. The method of claim 1, further comprising:
measuring the signal quality of the pilot continuously upon initiating the linger timer until expiration of the linger timer; and
pausing the linger timer if the signal quality of the pilot is detected to drop below the entry threshold.

12. The method of claim 1, further comprising measuring the signal quality of the pilot N times upon initiating the linger timer, wherein N is an integer.

13. The method of claim 12, further comprising determining whether to effectuate idle handoff to the base station based at least in part upon whether an average of the N samples exceeds a threshold.

14. The method of claim 12, further comprising selecting whether to perform idle handoff to the base station at least in part as a function of whether at least M of the N samples are above the entry threshold, wherein M is an integer that is less than or equal to N.

15. The method of claim 1, further comprising ignoring the linger timer when conditions of a current pilot received from a source base station, upon which a mobile device is currently camped, deteriorate below a certain level.

16. The method of claim 1, further comprising entering the base station without waiting for expiration of the linger timer to place a call to be initiated by a mobile device when the base station is a preferred femto cell base station.

17. The method of claim 1, further comprising handing off from a macro cell base station to the base station, identified as a first preferred femto cell base station, upon expiration of the linger timer.

18. The method of claim 17, further comprising remaining associated with the first preferred femto cell base station while a measured signal quality of a pilot received from the first preferred femto cell base station remains above a drop threshold independent of a signal quality of a pilot from at least one of a neighbor non-preferred femto cell base station or a neighbor macro cell base station.

19. The method of claim 17, further comprising handing off to a second preferred femto cell base station associated with a disparate pilot with a measured signal quality higher than the measured signal quality of the pilot received from the first preferred femto cell base station without implementing a linger timer.

20. A wireless communications apparatus, comprising:
at least one processor configured to:
monitor a signal quality of a pilot received from a base station;
identifying a type of the base station from which the pilot is received;
recognize whether the base station is preferred or non-preferred when the type of the base station is identified as a femto cell base station;
start a linger timer when the signal quality of the pilot is above an entry threshold and the type of the base station is identified as a femto cell base station; and
effectuate idle handoff to the base station upon expiration of the linger timer as a function of at least one subsequent measurement of signal quality of the pilot received from the base station and whether the base station is recognized as preferred or non-preferred.

21. The wireless communications apparatus of claim 20, further comprising:
at least one processor configured to:
discern the type of the base station from which the pilot is received based upon at least one of a preferred user zone list (PUZL), a femto neighbor list message (FNLM), an access point identification message (APIDM), or a primary synchronization code (PSC).

22. The wireless communications apparatus of claim 20, further comprising:
at least one processor configured to:
read a paging channel of the base station between sleep cycles to recognize whether the base station is preferred or non-preferred.

23. The wireless communications apparatus of claim 20, wherein the linger timer is implemented on a pilot by pilot basis.

24. The wireless communications apparatus of claim 20, further comprising:
at least one processor configured to:
effectuate idle handoff to the base station upon expiration of the linger timer if the at least one subsequent measurement of the signal quality of the pilot is above the entry threshold and the base station is recognized as being a preferred femto cell base station.

25. The wireless communications apparatus of claim 20, further comprising:
at least one processor configured to:
evaluate at least one idle handoff condition upon expiration of the linger timer to detect whether to perform idle handoff to the base station if the at least one subsequent measurement of the signal quality of the pilot is above the entry threshold and the base station is identified as being a non-preferred femto cell base station.

26. The wireless communications apparatus of claim 20, further comprising:
at least one processor configured to:
ignore the linger timer when a signal quality of a current pilot received from a source base station, upon which a mobile device is currently camped, deteriorates below a certain level.

27. The wireless communications apparatus of claim 20, further comprising:
at least one processor configured to:
enter the base station without waiting for expiration of the linger timer to place a call to be initiated by a mobile device when the base station is a preferred femto cell base station.

28. The wireless communications apparatus of claim 20, further comprising:
at least one processor configured to:
remain camped on a preferred femto cell base station as opposed to handing off to one of a non-preferred femto cell base station or a macro cell base station as long as a signal quality of a pilot from the preferred femto cell base station is above a drop threshold.

29. An apparatus, comprising:
means for measuring a signal quality of a pilot obtained from a base station;
means for recognizing a type of the base station from which the pilot is obtained;
means for starting a linger timer when the signal quality of the pilot is above an entry threshold and the base station is recognized as a femto cell base station; and
means for effectuating idle handoff to the base station upon expiration of the linger timer based upon one or more subsequent measurements of signal quality of the pilot obtained from the base station.

30. The apparatus of claim 29, further comprising means for identifying whether the base station is preferred or non-preferred.

31. The apparatus of claim 30, further comprising means for remaining associated with the base station when the base station is a preferred femto cell base station while the signal quality of the pilot is above a drop threshold.

32. The apparatus of claim 29, wherein the linger timer is applied on a pilot by pilot basis.

33. The apparatus of claim 29, wherein the signal quality is a received strength of the pilot over a total received signal strength on a carrier.

34. A computer program product, comprising:
a computer-readable medium comprising:
code for causing at least one computer to measure a signal quality of a pilot received from a base station;
code for causing at least one computer to identify whether the base station from which the pilot is received is a femto cell base station or a macro cell base station;
code for causing at least one computer to initiate a linger timer when the signal quality of the pilot exceeds an entry threshold and the base station is identified as a femto cell base station; and
code for causing at least one computer to perform idle handoff to the base station upon expiration of the linger timer as a function of at least one subsequent measurement of signal quality of the pilot received from the base station.

35. The computer program product of claim 34, wherein the computer-readable medium further comprises code for causing at least one computer to discern whether the base station from which the pilot is received is a femto cell base station or a macro cell base station based upon at least one of a preferred user zone list (PUZL), a femto neighbor list message (FNLM), an access point identification message (APIDM), or a primary synchronization code (PSC).

36. The computer program product of claim 34, wherein the computer-readable medium further comprises code for causing at least one computer to recognize whether the base station is preferred or non-preferred when the base station is identified as being a femto cell base station.

37. The computer program product of claim 34, wherein a mobile device remains associated with a source base station without handing off to the base station corresponding to the pilot upon which the linger timer is initiated during a period of time associated with the linger timer.

38. The computer program product of claim 34, wherein the computer-readable medium further comprises code for causing at least one computer to effectuate idle handoff to the base station upon expiration of the linger timer if the at least one subsequent measurement of the signal quality of the pilot is above the entry threshold and the base station is recognized as being a preferred femto cell base station.

39. The computer program product of claim 34, wherein the computer-readable medium further comprises code for causing at least one computer to evaluate at least one idle handoff condition upon expiration of the linger timer to detect whether to perform idle handoff to the base station if the at least one subsequent measurement of the signal quality of the pilot is above the entry threshold and the base station is identified as being a non-preferred femto cell base station.

40. The computer program product of claim 34, wherein the computer-readable medium further comprises code for causing at least one computer to maintain an association with a preferred femto cell base station in preference to handing off to a non-preferred femto cell base station or a macro cell base station.

41. An apparatus, comprising:
a pilot strength measurement component that evaluates signal quality of each pilot received from one or more base stations;
a type identification component that detects whether each received pilot corresponds to a femto cell base station or a macro cell base station;
a timer component that initiates a linger timer for a particular pilot recognized as corresponding to a femto cell base station with a signal quality detected by pilot strength measurement component above an entry threshold; and
a handover selection component that evaluates whether to perform an idle handover to the femto cell base station at a time of expiration of the linger timer.

42. The apparatus of claim 41, further comprising a preference recognition component that detects whether the femto cell base station is a preferred femto cell base station or a non-preferred femto cell base station.
